(19) United States
(12) Patent Application Publication
(10) Pub. No.: US 2014/0184968 A1
(43) Pub. Date: Jul. 3, 2014

(54) LIQUID CRYSTAL DISPLAY DEVICE

(71) Applicant: Semiconductor Energy Laboratory Co., Ltd., Atsugi-shi (JP)

(72) Inventors: Yasuhiro NIIKURA, Komae (JP); Momoko KATO, Iwaki (JP); Daisuke KUBOTA, Atsugi (JP); Makoto IKENAGA, Atsugi (JP)

(73) Assignee: Semiconductor Energy Laboratory Co., Ltd., Atsugi-shi (JP)

(21) Appl. No.: 14/134,361

(22) Filed: Dec. 19, 2013

(30) Foreign Application Priority Data
Dec. 28, 2012 (JP) 2012-286774

(51) Int. Cl. G02F 1/00

(52) U.S. Cl. CPC G02F 1/0045
USPC 349/42; 349/167

(57) ABSTRACT

Provided is a novel liquid crystal display device without deterioration of display quality. The liquid crystal display device includes a pixel for displaying a still image with a frame frequency of 1 Hz or lower. The pixel includes a liquid crystal element which includes a liquid crystal layer and has a cell gap of d (μm). The liquid crystal layer includes a liquid crystal composition which includes a liquid crystal material. The helical pitch of the liquid crystal material is longer than or equal to 4d μm and shorter than or equal to 8d μm. With this structure, a change in voltage applied to a pixel can be kept within an acceptable range of a deviation in gray level for displaying the same image. Thus, flickers due to a low refresh rate can be reduced, which leads to an increase in display quality.

### BACKGROUND OF THE INVENTION

1. Field of the Invention

The present invention relates to an object, a method, or a manufacturing method. The present invention also relates to a process, a machine, manufacture, or a composition of matter. In particular, the present invention relates to, for example, a semiconductor device, a display device, a light-emitting device, a power storage device, a driving method thereof, or a manufacturing method thereof. In particular, the present invention relates to a semiconductor device including an oxide semiconductor, a light-emitting device, or a liquid crystal display device, for example.

Note that the liquid crystal display device refers to a device including a liquid crystal element. The liquid crystal display device includes a driver circuit for driving a plurality of pixels and the like. Further, the liquid crystal display device may include a control circuit, a power supply circuit, a signal generation circuit, or the like provided over a different substrate.

2. Description of the Related Art

As a result of recent technological innovation, commoditization of liquid crystal display devices has progressed. In order to gain a competitive edge in the commoditization, higher-value added products have been required.

Although great technological innovation of mobile devices is continued, advance in performance of batteries have not caught up with the increase of power consumption associated with the increase of performance of the mobile devices. Thus, many users are dissatisfied with the usable life on a single charge. Therefore, as an additional value required of mobile liquid crystal display devices, reduction in power consumption has attracted attention.

For example, Patent Document 1 discloses the structure of a display device whose power consumption is reduced by reducing the frequency of writing signals (also referred to as “refresh”) for the same image in the case of continuously displaying the same image (still image).

The refresh operation needs to be performed such that change of an image caused by the refresh operation is not distinguished by users. The frequency of refresh operations is referred to as a refresh rate.

### REFERENCE

### Patent Document

[Patent Document 1] Japanese Published Patent Application No. 2011-237760

### SUMMARY OF THE INVENTION

A display device with a reduced refresh rate also needs to be driven such that change of a still image caused by the refresh operation is not distinguished by users, as described above.

However, a voltage corresponding to a signal applied to changes with time. When the voltage applied to a pixel changes in excess of an acceptable range of a deviation in gray level for displaying the same image, viewers perceive flickers in the image, which leads to a decrease in display quality.

In view of the above, an object of one embodiment of the present invention is to provide a novel liquid crystal display device without a decrease in display quality. Another object of one embodiment of the present invention is to provide a semiconductor device or the like with low off-state current. Another object of one embodiment of the present invention is to provide a semiconductor device or the like with low power consumption. Another object of one embodiment of the present invention is to provide an eye-friendly display device or the like. Another object of one embodiment of the present invention is to provide a semiconductor device or the like using a transparent semiconductor layer. Another object of one embodiment of the present invention is to provide a semiconductor device or the like using a semiconductor layer with high reliability. Another object of one embodiment of the present invention is to provide a novel semiconductor device. Another object of one embodiment of the present invention is to provide a good semiconductor device or the like. Note that the descriptions of these problems do not disturb the existence of other problems. Note that in one embodiment of the present invention, there is no need to achieve all the objects. Other objects will be apparent from and can be derived from the description of the specification, the drawings, the claims, and the like.

One embodiment of the present invention is a liquid crystal display device including a pixel. The pixel has a function of being supplied with an image signal at a frequency of 1 Hz or lower and a function of displaying a still image. The pixel includes a liquid crystal element. The liquid crystal element includes a liquid crystal layer. The liquid crystal layer includes a region whose cell gap is d (μm). The liquid crystal layer includes a liquid crystal material. The liquid crystal material includes a region whose helical pitch is longer than or equal to 4d μm and shorter than or equal to 8d μm.

One embodiment of the present invention is a liquid crystal display device including a pixel for displaying a still image at a frame frequency of 1 Hz or lower. The pixel includes a liquid crystal element which includes a liquid crystal layer and has a cell gap of d (μm). The liquid crystal layer includes a liquid crystal composition which includes a liquid crystal material. The helical pitch of the liquid crystal material is longer than or equal to 4d μm and shorter than or equal to 8d μm.

One embodiment of the present invention is a liquid crystal display device including a pixel for displaying a still image at a frame frequency of 1 Hz or lower. The pixel includes a transistor and a liquid crystal element which includes a liquid crystal layer and which has a cell gap of d (μm). The liquid crystal layer includes a liquid crystal composition which includes a liquid crystal material. The helical pitch of the liquid crystal material is longer than or equal to 4d μm and shorter than or equal to 8d μm.

Further, in the liquid crystal display device having the above structure, it is preferable that the transistor include a semiconductor layer and the semiconductor layer include an oxide semiconductor.

Further, in the liquid crystal display device having the above structure, it is preferable that the helical pitch be longer than or equal to 4d μm and shorter than or equal to 6d μm.

One embodiment of the present invention is a liquid crystal display device including a pixel for displaying a still image with a frame frequency of 1 Hz or lower. The pixel includes a liquid crystal element which includes a liquid crystal layer. The liquid crystal layer includes a liquid crystal composition which includes a liquid crystal material whose helical pitch is longer than or equal to 20 μm and shorter than or equal to 40 μm.

One embodiment of the present invention is a liquid crystal display device including a pixel for displaying a still image with a frame frequency of 1 Hz or lower.

The pixel includes a transistor and a liquid crystal element which includes a liquid crystal layer and has a cell gap of d (μm). The liquid crystal layer includes a liquid crystal composition which includes a liquid crystal material. The helical pitch of the liquid crystal material is longer than or equal to 20 μm and shorter than or equal to 40 μm.

Further, in the liquid crystal display device having the above structure, it is preferable that the transistor include a semiconductor layer and the semiconductor layer include an oxide semiconductor.

Further, in the liquid crystal display device having the above structure, it is preferable that the helical pitch be longer than or equal to 20 μm and shorter than or equal to 30 μm.

In the liquid crystal display device having the above structure, the liquid crystal element is preferably driven in a TN mode.

In the liquid crystal display device of one embodiment of the present invention, it is preferable that the frame frequency be less than or equal to 0.2 Hz.

In one embodiment of the present invention, a change in voltage applied to a pixel can be kept within an acceptable range of a deviation in gray level for displaying the same image. Thus, flickers due to a low refresh rate can be reduced, which leads to an increase in display quality.

### BRIEF DESCRIPTION OF THE DRAWINGS

FIG. 1 is a graph showing the current-transmittance characteristics of a liquid crystal layer.

FIGS. 2A and 2B are graphs showing the transmittance-voltage characteristics of a liquid crystal layer. FIG. 2C is a schematic cross-sectional view of the liquid crystal layer.

FIG. 3 is a graph showing change of V₂₀-V₈₀ with respect to the helical pitch.

FIG. 4 is a graph showing change of the maximum transmittance with respect to the helical pitch.

FIG. 5 is a graph showing change of V₂₀-V₈₀ and the helical pitch with respect to the added amount of a chiral agent.

FIG. 6 is a block diagram illustrating a structure of a liquid crystal display device having a display function of one embodiment of the present invention.

FIGS. 7A and 7B illustrate a structure of a display portion of a liquid crystal display device having a display function of one embodiment of the present invention.

FIG. 8 illustrates a structure of a display portion of a liquid crystal display device having a display function of one embodiment of the present invention.

FIG. 9 is a circuit diagram illustrating a liquid crystal display device having a display function of one embodiment of the present invention.

FIGS. 10A-1, 10A-2, 10B-1, 10B-2, and 10C are diagrams for explaining source line inversion driving and dot inversion driving of a liquid crystal display device having a display function of one embodiment of the present invention.

FIG. 11 is a timing chart showing the source line inversion driving and the dot inversion driving of the liquid crystal display device having a display function of one embodiment of the present invention.

FIGS. 12A and 12B illustrate a structure of a display device of one embodiment of the present invention.

FIGS. 13A and 13B illustrate a touch panel and a liquid crystal module including the touch panel.

FIG. 14 illustrates a touch panel and a liquid crystal module including the touch panel.

FIGS. 15A and 15B illustrate a structural example of a transistor according to one embodiment of the present invention.

FIGS. 16A to 16D illustrate an example of a method for forming a transistor according to one embodiment of the present invention.

FIGS. 17A and 17B illustrate structural examples of a transistor according to one embodiment of the present invention.

FIGS. 18A to 18C illustrate structural examples of a transistor according to one embodiment of the present invention.

FIGS. 19A to 19C illustrate electronic devices according to one embodiment of the present invention.

FIGS. 20A and 20B are diagrams for explaining display according to one embodiment of the present invention.

FIGS. 21A and 21B are diagrams for explaining display according to one embodiment of the present invention.

FIGS. 22A and 22B illustrate a structural example of a display device of one embodiment of the present invention.

FIG. 23 is a graph showing emission spectra of a backlight.

FIGS. 24A and 24B illustrate the structure of the display device according to Embodiment 1.

FIGS. 25A to 25C illustrate an electronic device in accordance with one embodiment of the present invention.

### DETAILED DESCRIPTION OF THE INVENTION

Hereinafter, embodiments will be described with reference to drawings. However, the embodiments can be implemented with various modes. It will be readily appreciated by those skilled in the art that modes and details can be changed in various ways without departing from the spirit and scope of the present invention. Thus, the present invention should not be interpreted as being limited to the following description of the embodiments.

In the reference drawings, the size, the thickness of layers, and/or regions may be exaggerated for clarity in some cases. Therefore, embodiments of the present invention are not limited to such scales. Note that drawings are schematic views of ideal examples, and the embodiments of the present invention are not limited to the shape or the value illustrated in the drawings. For example, variation in signal, voltage, or current due to noise or difference in timing can be included.

Note that in this specification and the like, a transistor is an element having at least three terminals of a gate, a drain, and a source. In addition, the transistor has a channel region between a drain (a drain terminal, a drain region, or a drain electrode) and a source (a source terminal, a source region, or a source electrode), and current can flow through the drain region, the channel region, and the source region.

Here, since the source and the drain of the transistor change depending on the structure, the operating condition, and the like of the transistor, it is difficult to define which is a source or a drain. Thus, a portion which functions as the source and a portion which functions as the drain are not referred to as a source and a drain and one of the source and the drain is referred to as a first electrode and the other thereof is referred to as a second electrode in some cases.

Note that in this specification, ordinal numbers such as “first”, “second”, and “third” are used in order to avoid confusion among components, and the terms do not limit the components numerically.

Note that in this specification, when it is described that “A and B are connected to each other”, the case where A and B are electrically connected to each other is included in addition to the case where A and B are directly connected to each other. Here, the description “A and B are electrically connected to each other” means the following case: when an object having any electrical function exists between A and B, an electric signal can be transmitted and received between A and B.

Note that in this specification, terms for describing arrangement, such as “over” and “under”, are used for convenience for describing a positional relation between components with reference to drawings. Further, a positional relation between components is changed as appropriate in accordance with a direction in which each component is described. Thus, there is no limitation to terms used in this specification, and description can be made appropriately depending on the situation.

Note that positional relations of circuit blocks in block diagrams are specified for description. Even in the case where different circuit blocks have different functions, they may be provided in an actual circuit or region so that different functions can be achieved in the same circuit or region. Functions of circuit blocks in block diagrams are specified for description. Even in the case where one circuit block is illustrated, blocks may be provided in an actual circuit or region so that processing performed by one circuit block is performed by a plurality of circuit blocks.

Note that a pixel corresponds to a display unit controlling the luminance of one color component (e.g., any one of R (red), G (green), and B (blue)). Therefore, in a color display device, the minimum display unit of a color image is composed of three pixels of an R pixel, a G pixel, and a B pixel. Note that the color of the color elements is not necessarily of three varieties and may be of three or more varieties or may include a color other than RGB.

### Embodiment 1

In this embodiment, a basic structure of one embodiment of the present invention is described.

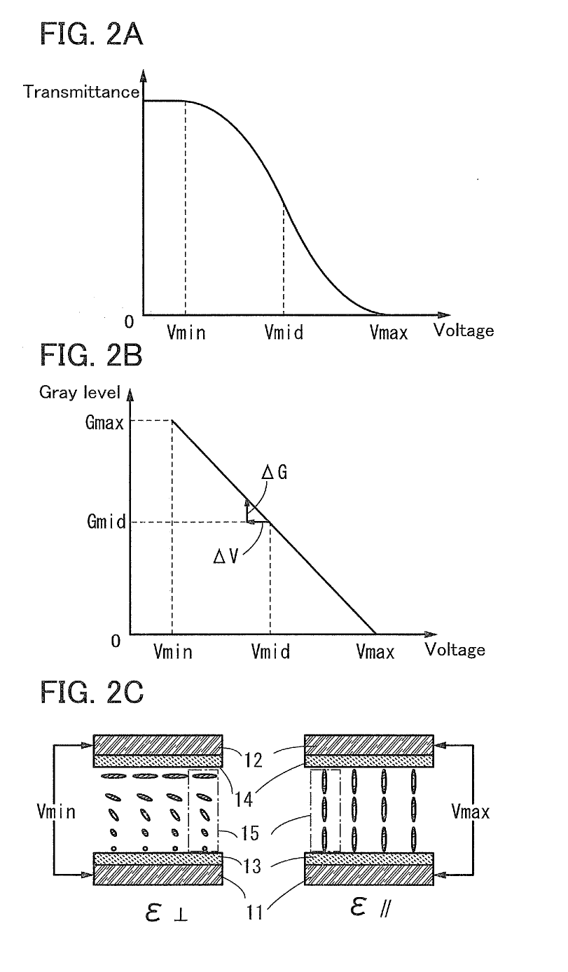

First, characteristics of a liquid crystal layer are described with reference to FIGS. 2A to 2C. FIG. 2A is a graph showing voltage-transmittance characteristics of a liquid crystal layer in a TN mode.

The graph in FIG. 2A shows a curve of a normally-white liquid crystal element. In a liquid crystal layer, orientations of liquid crystal molecules in the liquid crystal layer are changed by an electric field in accordance with voltage applied between electrodes between which the liquid crystal layer is sandwiched, and light is polarized by the change in orientation, so that the light transmittance of the liquid crystal layer is controlled. In FIG. 2A, the voltage Vmax is voltage at which the transmittance of light through the liquid crystal layer becomes 0. The voltage Vmin is voltage at which the transmittance of light through the liquid crystal layer becomes the maximum value. The voltage Vmid is voltage at which the transmittance of light through the liquid crystal layer becomes a half value (50%).

The graph in FIG. 2B shows a relation of voltage applied to the liquid crystal layer and a gray level. In FIG. 2B, for example, in the case where a black image or a white image is displayed, the light transmittance is changed by application of the voltage Vmax or the voltage Vmin; thus, the image can be displayed by switching the gray level between 0 and Gmax.

In FIG. 2B, in the case where an image is displayed with multi gray levels for expressing a color shade, the voltages Vmax, Vmid, and Vmin are applied, so that the light transmittance is changed and the gray level is switched between Gmax, Gmid, and 0, whereby the image can be displayed. In order to increase the gray levels, a plurality of voltage levels is set between the voltage Vmax and the voltage Vmin. The light transmittance is changed in accordance with the voltage level, which is utilized for achieving a liquid crystal display device capable of displaying an image with a plurality of gray levels.

In that case, when a value of voltage applied to the liquid crystal layer is not changed, the light transmittance is also not changed; thus, a desired gray level can be obtained. On the other hand, a value of voltage applied to a liquid crystal layer in a pixel in an active-matrix liquid crystal display device is changed with time due to current flowing through the liquid crystal layer. Specifically, as a certain period of time passes and the value of voltage is changed by ΔV, the gray level is also changed by ΔG When the value of voltage applied to a pixel is changed to a value outside the acceptable range of a deviation in gray level for displaying the same image, flickers might be perceived by viewers, which means a decrease in display quality.

FIG. 2C is a cross-sectional schematic view of electrodes between which a liquid crystal layer is sandwiched. FIG. 2C illustrates an oriented state of the liquid crystal layer to which the voltage Vmin in FIG. 2A is applied (an initial orientation state) and an oriented state of the liquid crystal layer to which the voltage Vmax is applied (an saturated orientation state).

Note that the initial orientation state refers to a state of liquid crystal molecules to which voltage is not applied. The initial orientation state in the TN liquid crystal is a state where liquid crystal molecules are twisted by 90° between electrodes. The saturated orientation state refers to a state of liquid crystal molecules to which voltage is applied in which the liquid crystal molecules are tilted or rise and the orientations are hardly changed by application of a higher voltage.

In FIG. 2C, cross sections of a first electrode 11, a second electrode 12, an alignment film 13, an alignment film 14, and a liquid crystal molecules 15 are illustrated. Note that the first electrode 11 corresponds to a pixel electrode, and the second electrode 12 corresponds to a counter electrode.

The cause of flickers which are perceived when a still image is displayed at a reduced frame frequency is that applied voltage is not maintained and is changed from any cause.

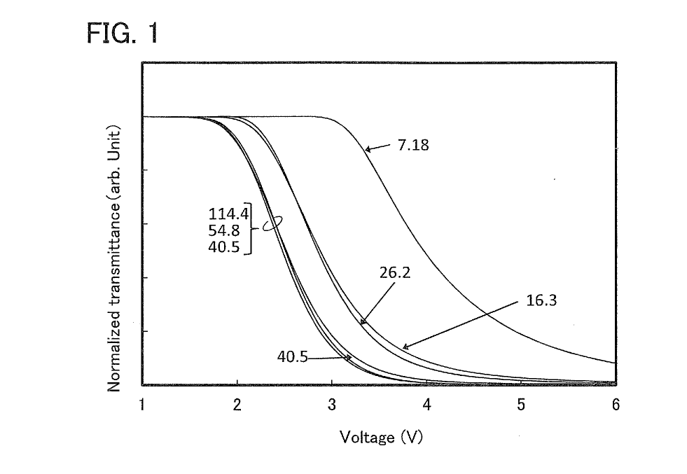

FIG. 1 shows changes of transmittance with respect to applied voltage of liquid crystal elements driven in a TN mode (i.e., V-T characteristics). The values in the graph indicate the helical pitches (μm) of liquid crystal materials in liquid crystal compositions contained in the elements. The helical pitches were measured by the Grandjean-Cano wedge method. Note that a long helical pitch (60 μm or longer) is an estimated value. As the liquid crystal material, the mixed liquid crystal ZLI-4792 (produced by Merck) was used.

In liquid crystal elements, the transmittance is changed depending on applied voltage as shown in FIG. 1, so that gray scale is controlled and display is obtained. It can be found from FIG. 1 that as the helical pitch gets shorter, the absolute value of slope gets smaller.

As the inclination of transmittance with respect to voltage gets smaller, a value of the transmittance that is changed in accordance with the change of voltage gets smaller. As a result, a flicker can be less perceived.

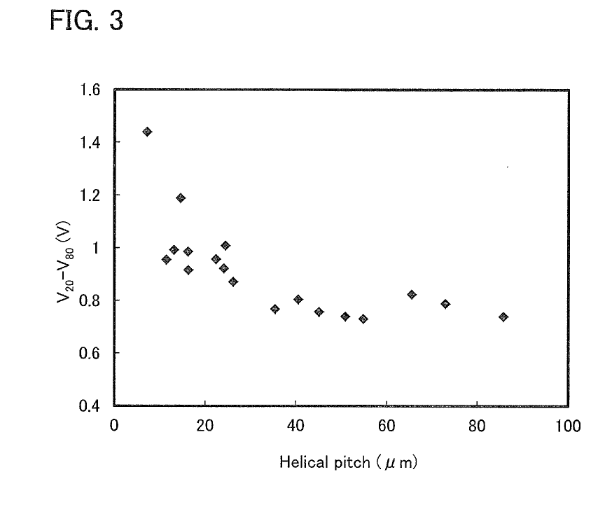

FIG. 3 shows results of plotting a difference between voltage with a transmittance of 20% and voltage with a transmittance of 80% (V₂₀-V₈₀ (V)) against the helical pitch of the liquid crystal material. From FIG. 3, it is found that V₂₀-V₈₀ increases as the helical pitch decreases in a region where the helical pitch is 40 μm or shorter, and this increase is significant with a helical pitch of 30 μm or shorter. When V₂₀-V₈₀ increases, V-T characteristics shown in FIG. 1 become broad and the change of transmittance in accordance with the change of voltage gets smaller. As a result, a flicker can be less perceived.

Since a liquid crystal material whose helical pitch is short has a stronger twist power, higher voltage is applied to a TN-mode liquid crystal element, which is driven such that the liquid crystal material is untwisted from being twisted 90°. As a result, V₂₀-V₈₀ is increased.

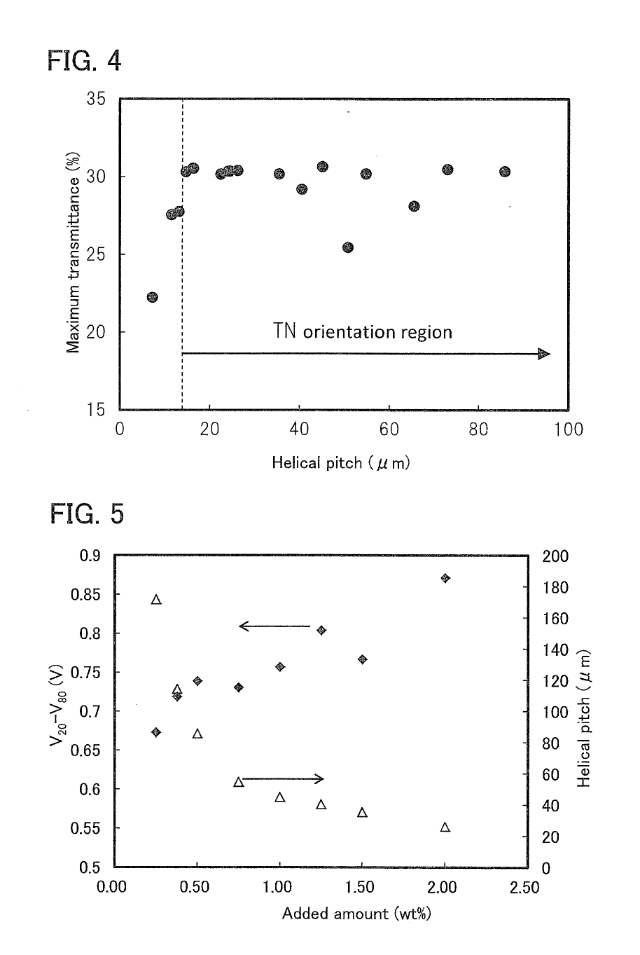

FIG. 4 shows maximum transmittance (%) with respect to the helical pitch. The transmittance is a value when the luminance of a light source is 100%. It is found from the results that the maximum transmittance is extremely decreased in a region where the helical pitch is 20 μm or shorter. Further, a phenomenon in which operation of the liquid crystal element is unstable was also observed. This is considered because the twist strength of the liquid crystal is too strong and thus the alignment becomes unstable. Therefore, the helical pitch is preferably 20 μm or longer.

From these results, in the pixel including the liquid crystal element that displays a still image at a frame frequency of 1 Hz or lower, the helical pitch of the liquid crystal material in a liquid crystal composition contained in the liquid crystal element is longer than or equal to 20 μm and shorter than or equal to 40 μm, preferably longer than or equal to 20 μm and shorter than or equal to 30 μm.

Note that a cell gap of the liquid crystal element which is examined in this embodiment is 5 μm. In the TN mode, a twist angle is constant at 90° with respect to the cell gap, and the standard of twist strength differs depending on a cell gap. Therefore, with the use of a cell gap d, the helical pitch is denoted by longer than or equal to 4d and shorter than or equal to 8d, preferably longer than or equal to 4d and shorter than or equal to 6d.

As described above, by setting the helical pitch of a liquid crystal material in a liquid crystal layer to higher than or equal to 4d and shorter than or equal to 8d, preferably higher than or equal to 4d and shorter than or equal to 6d (note that d means a cell gap (μm)), a deviation in gray level can be kept within the acceptable range for displaying the same image, so that flickers can be reduced. As a result, display quality can be improved.

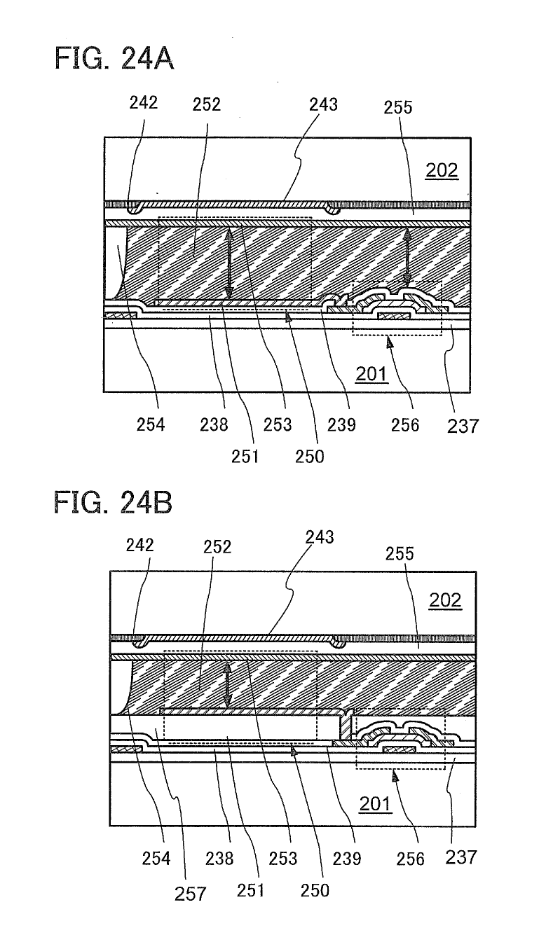

FIGS. 24A and 24B each show part of a cross-sectional view of a liquid crystal display device. In the figures, a first substrate 201, a second substrate 202, an insulating layer 237, an insulating layer 238, an insulating layer 239, a black matrix 242, a color filter 243, a liquid crystal element 250, a first electrode 251, a liquid crystal 252, a second electrode 253, a spacer 254, an overcoat 255, a transistor 256, and a planarization film 257 are illustrated. The details of them are omitted here because they will be described in Embodiment 6.

The cell gap, which is described above, refers to the distance indicated by an arrow in the figure.

Note that, more precisely, the cell gap means the distance between the first electrode 251 and the second electrode 253. In addition, since the cell gap is maintained by the spacer 254, the height or the diameter of the spacer can be regarded as the cell gap.

Note that the acceptable deviation in gray level for displaying the same image is 0 or more and 3 or less when the image is displayed by controlling 256 levels of transmittance, for example. When the deviation in gray level for displaying the same image is 0 or more and 3 or less, viewers hardly perceive flickers. As another example, when the image is displayed by controlling 1024 levels of transmittance, the acceptable range of a deviation in gray level is 0 or more and 12 or less. That is, the acceptable range of a deviation in gray level for displaying the same image is preferably more than or equal to 1% and less than or equal to 1.2% of the maximum gray levels.

Note that it is particularly preferable that the structure of one embodiment of the present invention in which the helical pitch of a liquid crystal material is set longer than or equal to 4d and shorter than or equal to 8d, preferably longer than or equal to 4d and shorter than or equal to 6d (note that d means cell gap (μm)) be combined with driving by which moving image display and still image display are performed at different refresh rates. In a liquid crystal display device which operates at different refresh rates, when moving image display is changed to still image display, the frame frequency is changed from 60 Hz to less than or equal to 1 Hz, preferably from 60 Hz to less than or equal to 0.2 Hz, whereby the power consumption is reduced. That is, the structure of this embodiment is suitable as a structure in which the refresh rate is reduced at the time of still image display.

In the liquid crystal display device which performs display at different refresh rates, it is preferable to reduce power consumption and prevent a decrease in display quality at the time of moving image display and at the time of still image display. At the time of still image display, as the refresh rate is set lower, the time interval between applications of voltage to a pixel gets longer. In other words, when the refresh rate at the time of still image display is decreased, there is a certain period of time during which voltage is not applied to a pixel.

Accordingly, in the case of driving at a decreased refresh rate at the time of still image display, it is important to keep voltage applied to a pixel at a certain value. In addition, since the frame frequency is increased in the case of driving at an increased refresh rate at the time of moving image display, setting driving voltage low is important for reducing power consumption.

In one embodiment of the present invention, driving voltage can be set low as compared with in the case of a liquid crystal material having a helical pitch of 4d or shorter. In a liquid crystal display device which operates at a low driving voltage, an increase in power consumption, which is caused by an increase in frame frequency when still image display is changed to moving image display, can be suppressed.

A variety of liquid crystal compositions for a TN liquid crystal can be used as the liquid crystal composition used for the liquid crystal display device in this embodiment. A liquid crystal composition containing a liquid crystal material having the above-described helical pitch can be obtained by adding a chiral agent in the amount that the helical pitch can be induced, to any of the liquid crystal compositions.

Any chiral agent can be used as long as the chiral agent at the amount that the helical pitch can be induced can be dissolved in the liquid crystal composition that is used. Although the amount of a chiral agent at which the helical pitch can be induced differs depending on the chiral agent, it is a few wt % as shown in FIG. 5; thus, a wide variety of chiral agents can be used. FIG. 5 is a graph showing relation between helical pitch and V₂₀-V₈₀ against the added amount of a chiral agent. It is found that as the added amount of a chiral agent is increased, V₂₀-V₈₀ is increased and the helical pitch is shortened.

Data from many kinds of chiral agents as the chiral agent in FIG. 1, FIG. 3, and

FIG. 4 are gathered. For example, 1,4:3,6-dianhydro-2,5-bis[4-(n-hexyl-1-oxy)benzoic acid] sorbitol (abbreviation: ISO-(60BA)₂, (4R,5R)-bis[benzyloxy-di(phenanthrene-9-yl)methyl]-2,2-dimethyl-1, 3-dioxolane (abbreviation: R-DOL-Pn-O 1Ph), 1,4:3,6-dianhydro-D-glucitol 2,5-dibenzoate (abbreviation: ISO-(EP)₂), (4R,5R)-4,5-b is [hydroxy-di(phenanthrene-9-yl)methyl]-2,2-dimethyl-1,3-dioxolane (abbreviation: R-DOL-Ph), (4R,5R)-bis[benzyloxy-di(phenanthrene-9-yl)methyl]-2,2-dimethyl-1,3-dioxolane (abbreviation: R-DOL-Pn-OlPh). According to the results, dependence on the kind of the chiral agent is not found but dependence on the helical pitch is found. Therefore, a wide variety of materials can be used as the chiral agent.

Note that the structure formulae of the chiral agents are described as follows.

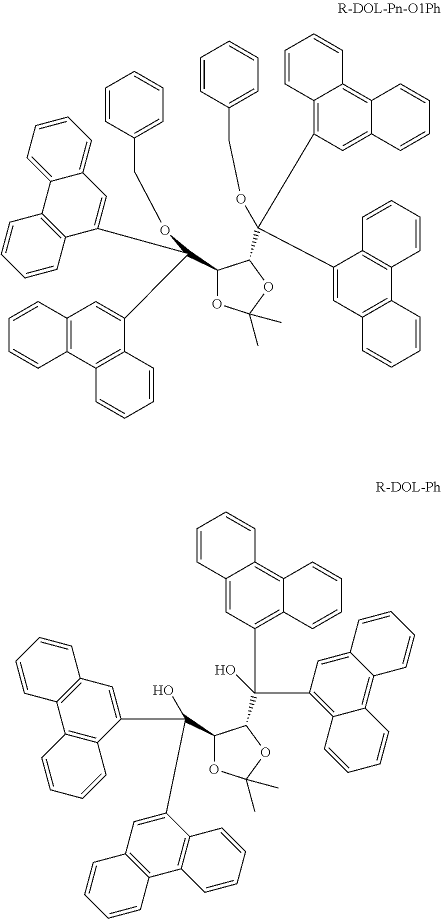

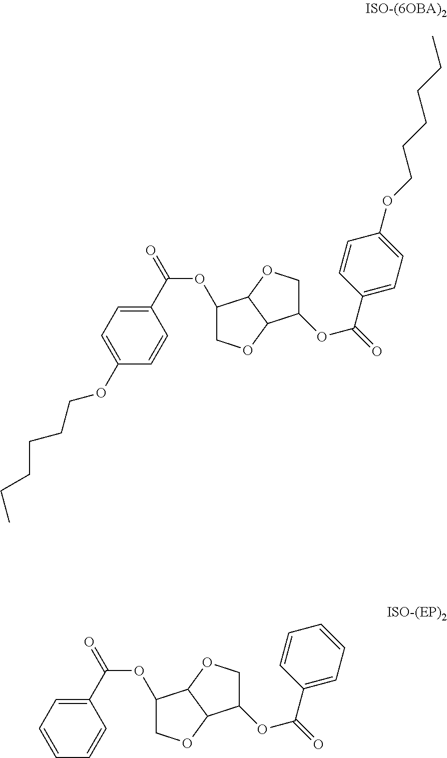 [SMILES: CCCCCCOc1ccc(C(=O)OC2COC3C(OC(=O)c4ccc(OCCCCCC)cc4)COC23)cc1 ; O=C(OC1COC2C(OC(=O)c3ccccc3)COC12)c1ccccc1]

In addition, since the R-DOL-Pn-OlPh is a chiral agent having high twist strength, only a small amount of the R-DOL-Pn-OlPh needs to be added to a liquid crystal composition, which is preferable.

In the case where still image display is performed at a refresh rate of lower than or equal to 1 Hz as in this embodiment, an eye-friendly liquid crystal display device can be achieved by satisfying the following requirements. The specific requirements are that when still image display is performed, images are displayed on a display portion in which light that is transmitted to the viewer side through the liquid crystal layer has a wavelength of longer than 420 nm, preferably longer than 440 nm, and the pixel resolution is greater than or equal to 150 ppi, preferably greater than or equal to 200 ppi.

### Embodiment 2

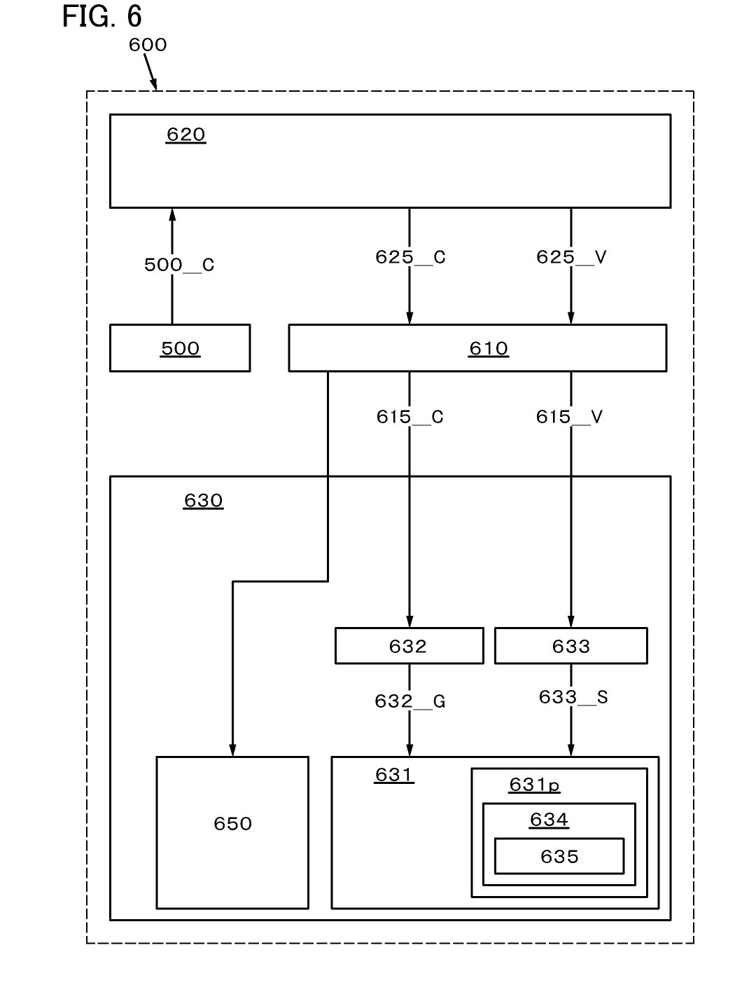

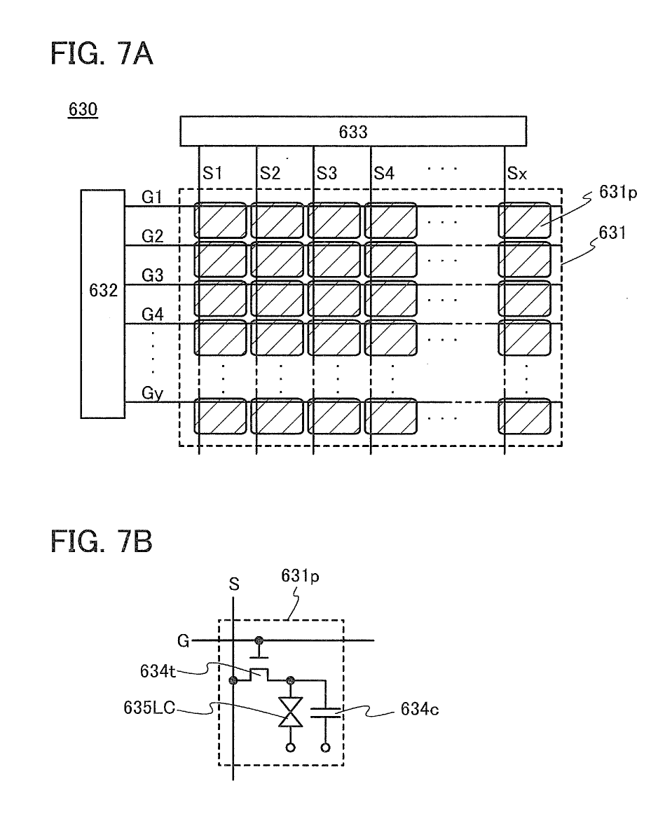

In this embodiment, an example of a liquid crystal display device including the liquid crystal layer described in Embodiment 1 is described with reference to FIG. 6 and FIGS. 7A and 7B.

Specifically, a liquid crystal display device which has a first mode in which a G signal is output at a frequency of 60 Hz or higher and a second mode in which the G signal is output at a frequency of 1 Hz or lower, preferably 0.2 Hz or lower is described. The G signal selects a pixel.

FIG. 6 is a block diagram of a structure of a liquid crystal display device having a display function of one embodiment of the present invention.

FIGS. 7A and 7B are a block diagram and a circuit diagram of a structure of a display portion in the liquid crystal display device having a display function of one embodiment of the present invention.

### <1. Structure of Liquid Crystal Display Device>

A liquid crystal display device 600 having a display function, which is described as an example in this embodiment and illustrated in FIG. 6, includes a pixel portion 631 including pixel circuits 634; the pixel circuits 634 which hold first driving signals (also referred to as S signals) 633_S input and include display elements 635; the display elements 635 display an image on the pixel portion 631 in accordance with the S signals 633_S; a first driver circuit (also referred to as S driver circuit) 633 which outputs the S signals 633_S to the pixel circuits 634; and a second driver circuit (also referred to as G driver circuit) 632 which outputs second driving signals (also referred to as G signals) 632_G for selecting the pixel circuits 634 to the pixel circuits 634.

The G driver circuit 632 has a first mode in which a G signal 632_G is output to a pixel at a frequency of 30 or more times per second, preferably a frequency of 60 or more times and less than 960 times per second and a second mode in which the G signal 632_G is output to a pixel at a frequency of one or more times per day and less than 0.1 time per second, preferably a frequency of one or more times per hour and less than once per second.

Note that in the G driver circuit 632, the first mode and the second mode are switched in accordance with a mode-switching signal.

The pixel circuit 634 is provided in a pixel 631p. A plurality of pixels 631p is provided in the pixel portion 631 in a display portion 630.

The liquid crystal display device 600 having a display function includes an arithmetic unit 620. The arithmetic unit 620 outputs a first-order control signal 625_C and a first-order image signal 625_V.

The liquid crystal display device 600 includes a control unit 610. The control unit 610 controls the S driver circuit 633 and the G driver circuit 632.

In the case where a liquid crystal element is used as the display element 635, a light supply portion 650 is provided in the display portion 630. The light supply portion 650 supplies light to the pixel portion 631 including the liquid crystal element, and functions as a backlight.

In the liquid crystal display device 600 having a display function, the frequency for selecting one from a plurality of pixel circuits 634 in the pixel portion 631 can be changed by the G signal 632_G output from the G driver circuit 632. As a result, the liquid crystal display device 600 can have a display function which gives less eye strain to users.

Elements included in the liquid crystal display device having a display function of one embodiment of the present invention are described below.

### <2. Arithmetic Unit>

The arithmetic unit 620 generates the first-order image signal 625_V and the first-order control signal 625_C.

The first-order control signal 625_C generated by the arithmetic unit 620 includes the mode-switching signal.

For example, the arithmetic unit 620 may output the first-order control signal 625_C including the mode-switching signal in accordance with an image-switching signal 500_C output from an input unit 500.

When the image-switching signal 500_C is input to the G driver circuit 632 in the second mode from the input unit 500 through the control unit 610, the G driver circuit 632 switches its mode from the second mode to the first mode, and outputs a G signal at least once, and then switches its modes to the second mode.

For example, when the input unit 500 senses a page turning operation, the input unit 500 outputs the image-switching signal 500_C to the arithmetic unit 620.

The arithmetic unit 620 generates the first-order image signal 625_V including the page turning operation signal and outputs the first-order image signal 625_V together with the first-order control signal 625_C including the image-switching signal 500_C.

The control unit 610 outputs the image-switching signal 500_C to the G driver circuit 632 and outputs the second-order image signal 615_V including the page turning operation signal to the S driver circuit 633.

The G driver circuit 632 switches its modes from the second mode to the first mode, and rewrites the G signal 632_G at a rate at which viewers cannot perceive a change in image by signal rewriting operation.

Meanwhile, the S driver circuit 633 outputs to the pixel circuits 634 the S signals 633_S generated from the second-order image signal 615_V including the page turning operation.

The pixel 631p can display many frame images including the page turning operation in a short time; thus the second-order image signal 615_V including smooth page turning operation can be displayed.

The arithmetic unit 620 may be configured to determine whether the first-order image signal 625_V output from the arithmetic unit 620 to the display portion 630 is an moving image or a still image, and output a signal for selecting the first mode when the first-order image signal 625_V is a moving image and output a signal for selecting the second mode when the first-order image signal 625_V is a still image.

Whether the first-order image signal 625_V is a moving image or a still image can be determined in accordance with a difference value in signal between one frame in the first-order image signal 625_V and the previous or next frame. When the difference value is larger than a predetermined value, the signal is a moving image; when the difference value is less than or equal to the predetermined value, the signal is a still image.

Alternatively, a structure can be employed in which when the second mode is switched to the first mode, the G signal 632_G is output a predetermined number of times which is larger than or equal to one, and then the first mode is switched to the second mode.

### <3. Control Unit>

The control unit 610 outputs the second-order image signal 615_V generated from the first-order image signal 625_V (see FIG. 6). Note that the control unit 610 may be configured to input the first-order image signal 625_V directly to the display portion 630.

The control unit 610 has a function of generating a second-order control signal 615_C (e.g., a start pulse signal SP, a latch signal LP, or a pulse width control signal PWC) from the first-order control signal 625_C including a synchronization signal (e.g., a vertical synchronization signal or a horizontal synchronization signal) and supplying the generated signal to the display portion 630. Note that the second-order control signal 615_C includes a clock signal CK or the like.

The control unit 610 may be provided with an inversion control circuit to have a function of inverting the polarity of the second-order image signal 615_V at a timing notified by the inversion control circuit. Specifically, the inversion of the polarity of the second-order image signal 615_V may be performed in the control unit 610 or in the display portion 630 in accordance with an instruction by the control unit 610.

The inversion control circuit has a function of determining timing of inverting the polarity of the second-order image signal 615_V by using a synchronization signal. For example, the inversion control circuit includes a counter and a signal generation circuit.

The counter has a function of counting the number of frame periods by using the pulse of a horizontal synchronization signal.

The signal generation circuit has a function of notifying timing of inverting the polarity of the second-order image signal 615_V to the control unit 610 so that the polarity of the second-order image signal 615_V is inverted every plural consecutive frame periods by using information on the number of frame periods that is obtained in the counter.

### <4. Display Portion>

The display portion 630 includes the pixel portion 631 including a display element 635 in each pixel and driver circuits such as the S driver circuit 633 and the G driver circuit 632. The pixel portion 631 includes a plurality of pixels 631p each provided with the display element 635 (see FIG. 6).

The second-order image signal 615_V that are input to the display portion 630 are supplied to the S driver circuit 633. In addition, power supply potentials and the second-order control signal 615_C are supplied to the S driver circuit 633 and the G driver circuit 632.

Note that the second-order control signals 615_C include an S driver circuit start pulse signal SP and an S driver circuit clock signal CK that control the operation of the S driver circuit 633; a latch signal LP; a G driver circuit start pulse SP and a G driver circuit clock signal CK that control the operation of the G driver circuit 632; a pulse width control signal PWC; and the like.

FIG. 7A illustrates an example of a structure of the display portion 630.

In the display portion 630 in FIG. 7A, the plurality of pixels 631p, a plurality of scan lines G for selecting the pixels 631p row by row, and a plurality of signal lines S for supplying the S signals 633_S generated from the second-order image signal 615_V to the selected pixels 631p are provided in the pixel portion 631.

The input of the G signals 632_G to the scan lines G is controlled by the G driver circuit 632. The input of the S signals 633_S to the signal lines S is controlled by the S driver circuit 633. Each of the plurality of pixels 631p is connected to at least one of the scan lines G and at least one of the signal lines S.

Note that the kinds and number of the wirings in the pixel portion 631 can be determined by the structure, number, and position of the pixels 631p. Specifically, in the pixel portion 631 illustrated in FIG. 7A, the pixels 631p are arranged in a matrix of x columns and y rows, and the signal lines S1 to Sx and the scan lines G1 to Gy are provided in the pixel portion 631.

### <4-1. Pixel>

Each pixel 631p includes the display element 635 and the pixel circuit 634 including the display element 635.

### <4-2. Pixel Circuit>

In this embodiment, FIG. 7B illustrates an example of a structure of the pixel circuit 634 in which a liquid crystal element 635LC is used as the display element 635.

The pixel circuit 634 includes a transistor 634t for controlling supply of the S signal 633_S to the liquid crystal element 635LC. An example of connection relation between the transistor 634t and the display element 635 is described.

A gate of the transistor 634t is connected to any one of the scan lines G1 to Gy. One of a source and a drain of the transistor 634t is connected to any one of the signal lines S1 to Sx. The other of the source and the drain of the transistor 634t is connected to a first electrode of the display element 635.

Note that pixel 631p may include, in addition to the capacitor 634c for holding voltage between a first electrode and a second electrode of the liquid crystal element 635LC, another circuit element such as a transistor, a diode, a resistor, a capacitor, or an inductor as needed.

In the pixel 631p illustrated in FIG. 7B, one transistor 634t is used as a switching element for controlling input of the S signal 633_S to the pixel 631p. However, a plurality of transistors which serve as one switching element may be used in the pixel 631p. In the case where the plurality of transistors serve as one switching element, the transistors may be connected to one another in parallel, in series, or in combination of parallel connection and series connection.

Note that the capacitance of the pixel circuit 634 may be adjusted as appropriate. For example, in the second mode to be described later, in the case where the S signal 633_S is held for a relatively long time (specifically, greater than or equal to 1/60 sec), the capacitor 634c is provided. Alternatively, the capacitance of the pixel circuit 634 may be adjusted by utilizing a structure other than the capacitor 634c. For example, with a structure in which the first electrode and the second electrode of the liquid crystal element 635LC are formed to overlap with each other, a capacitor may be substantially formed.

Note that the structure of the pixel circuit 634 can be selected depending on the kind of the display element 635 or the driving method.

<4-2a. Display Element>

The liquid crystal element 635LC includes a first electrode, a second electrode, and a liquid crystal layer including a liquid crystal material to which the voltage between the first electrode and the second electrode is applied. In the liquid crystal element 635LC, the alignment of liquid crystal molecules is changed in accordance with the level of voltage applied between the first electrode and the second electrode, so that the transmittance is changed. Accordingly, the transmittance of the display element 635 is controlled by the potential of the S signal 633_S; thus, gradation can be expressed.

Note that, besides the liquid crystal element 635LC, any of a variety of display elements such as an OLED element generating luminescence (electroluminescence) when an electric field is applied thereto and electronic ink utilizing electrophoresis can be used as the display element 635.

<4-2b. Transistor>

The transistor 634t controls whether to apply the potential of the signal line S to the first electrode of the display element 635. A predetermined reference potential Vcom is applied to the second electrode of the display element 635.

Note that a transistor including an oxide semiconductor can be suitably used as the transistor in the liquid crystal display device of one embodiment of the present invention. Embodiments 8 and 9 can be referred to for details of the transistor including an oxide semiconductor.

### <5. Light Supply Portion>

A plurality of light sources is provided in the light supply portion 650. The control unit 610 controls driving of the light sources in the light supply portion 650.

The light source in the light supply portion 650 can be a cold cathode fluorescent lamp, a light-emitting diode (LED), an OLED element generating luminescence (electroluminescence) when an electric field is applied thereto, or the like.

In particular, the intensity of blue light emitted by the light source is preferably weakened compared to that of light of any other color. Blue light included in light emitted by the light source reaches the retina in the eye without being absorbed by the cornea or the lens. Accordingly, weakening the intensity of blue light emitted by the light source compared to that of light of any other color makes it possible to reduce long-term effects of blue light on the retina (e.g., age-related macular degeneration), adverse effects of exposure to blue light until midnight on the circadian rhythm, and the like. The wavelength of the light emitted by the light source is preferably longer than 420 nm, more preferably longer than 440 nm.

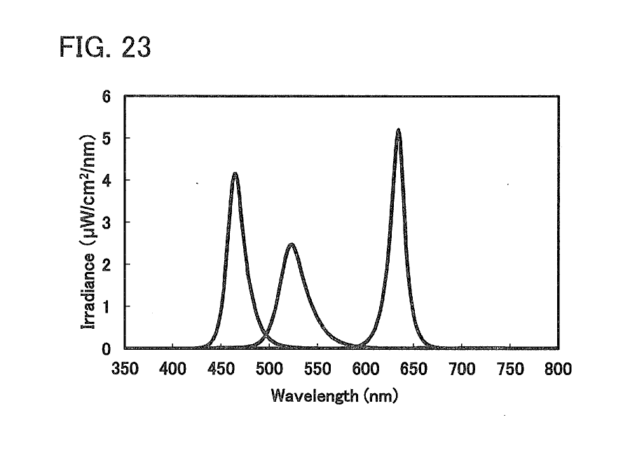

FIG. 23 shows preferable emission spectra of a backlight. As light sources of the backlight, light emitting diodes (LEDs) of three colors, R (red), G (green), and B (blue), are used. FIG. 23 shows emission spectra of the light emitting diodes. In FIG. 23, irradiance is hardly observed at a wavelength of 420 nm or shorter. A display portion with the backlight for which these light sources are used can reduce eye strain of Users.

In this structure, the luminance of short-wavelength light is lowered in accordance with the user's fatigue condition detected by the condition of the user's eye. The program makes it possible to reduce the user's eye fatigue and damage to the retina and prevent harm to the user's health.

### <6. Input Unit>

As the input unit 500, a touch panel, a touch pad, a mouse, a finger joystick, a trackball, a data glove, or an imaging device can be used, for example. In the arithmetic unit 620, an electric signal output from the input unit 500 can be associated with coordinates of a display portion. Accordingly, users can input an instruction for processing information displayed on the display portion.

Examples of information input with the input unit 500 by users are instructions for dragging an image displayed on the display portion to another position on the display portion; for swiping a screen for turning a displayed image and displaying the next image; for scrolling a continuous image; for selecting a specific image; for pinching a screen for changing the size of a displayed image; and for inputting handwritten characters.

Note that this embodiment can be freely combined with any of the other embodiments in this specification.

### Embodiment 3

In this embodiment, an example of a method for driving the liquid crystal display device (also referred to as a display device) described in Embodiment 2 will be described with reference to FIGS. 7A and 7B, FIG. 8, and FIG. 9.

FIGS. 7A and 7B are a block diagram and a circuit diagram illustrating a configuration of a display portion of a liquid crystal display device having a display function in one embodiment of the present invention.

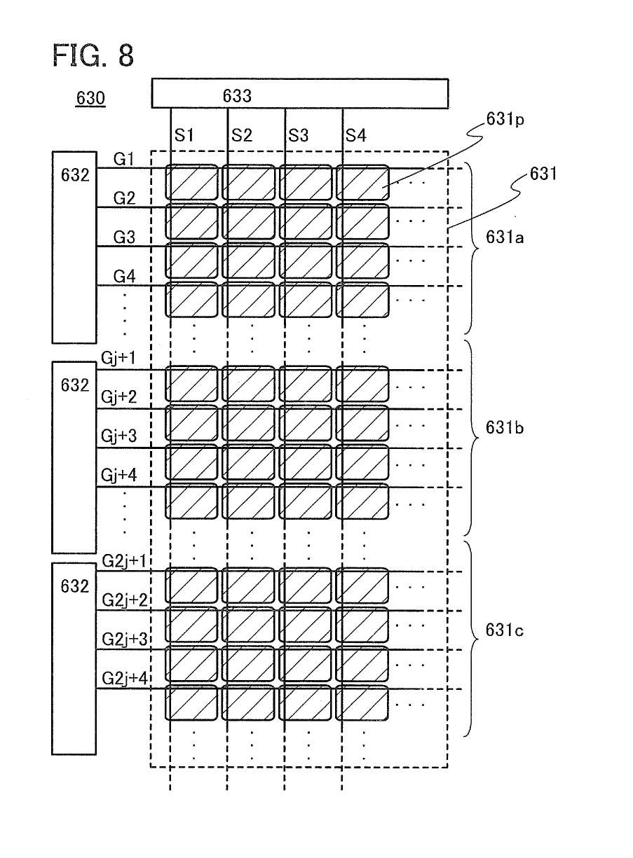

FIG. 8 is a block diagram illustrating a modification example of a configuration of a display portion of a liquid crystal display device having a display function in one embodiment of the present invention.

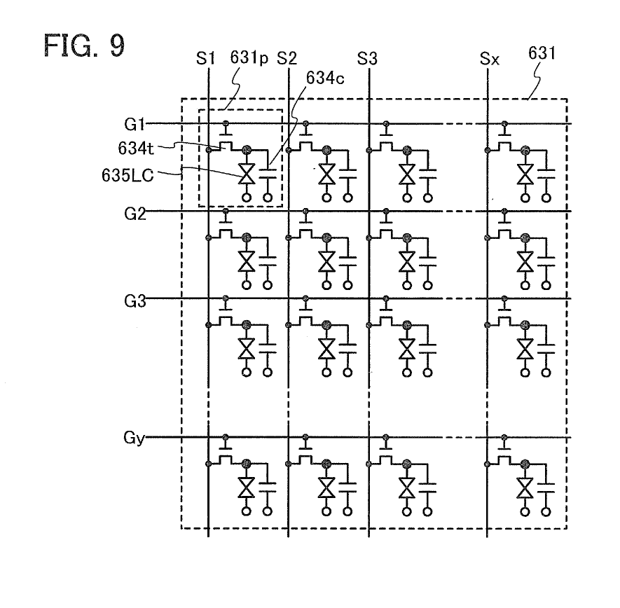

FIG. 9 is a circuit diagram illustrating a liquid crystal display device having a display function in one embodiment of the present invention.

<1. Method for Writing S Signals into Pixel Portion>

An example of a method for writing the S signals 633_S into the pixel portion 631 in FIG. 7A or FIG. 8 is described. Specifically, the method described here is a method for writing the S signal 633_S into each pixel 631p including the pixel circuit illustrated in FIG. 7B in the pixel portion 631.

<Writing Signals into Pixel Portion>

In a first frame period, the scan line G1 is selected by input of the G signal 632_G with a pulse to the scan line G1. In each of the plurality of pixels 631p connected to the selected scan line G1, the transistor 634t is turned on.

When the transistors 634t are on (in one line period), the potentials of the S signals 633_S generated from the second-order image signals 615_V are applied to the signal lines S1 to Sx. Through each of the transistors 634t that are on, charge corresponding to the potential of the S signal 633_S is accumulated in the capacitor 634c and the potential of the S signal 633_S is applied to a first electrode of the liquid crystal element 635LC.

In a period during which the scan line G1 is selected in the first frame period, the S signals 633_S having a positive polarity are sequentially input to all the signal lines S1 to Sx. Thus, the S signals 633_S having a positive polarity are input to first electrodes G1S1 to G1Sx in the pixels 631p that are connected to the scan line G1 and the signal lines S1 to Sx. Accordingly, the transmittance of the liquid crystal element 635LC is controlled by the potential of the S signal 633_S; thus, gradation is expressed by the pixels.

Similarly, the scan lines G2 to Gy are sequentially selected, and the pixels 631p connected to the scan lines G2 to Gy are sequentially subjected to the same operation as that performed while the scan line G1 is selected. Through the above operations, an image for the first frame can be displayed on the pixel portion 631.

Note that in one embodiment of the present invention, the scan lines G1 to Gy are not necessarily selected sequentially.

It is possible to employ dot sequential driving in which the S signals 633_S are sequentially input to the signal lines S1 to Sx from the S driver circuit 633 or line sequential driving in which the S signals 633_S are input all at once. Alternatively, a driving method in which the S signals 633_S are sequentially input to every plural signal lines S may be employed.

In addition, the method for selecting the scan lines G is not limited to progressive scan; interlaced scan may be employed for selecting the scan lines G

In given one frame period, the polarities of the S signals 633_S input to all the signal lines may be the same, or the polarities of the S signals 633_S to be input to the pixels may be inverted signal line by signal line.

<Writing Signals into Pixel Portion Divided into Plurality of Regions>

FIG. 8 illustrates a modification example of the structure of the display portion 630.

In the display portion 630 in FIG. 8, the plurality of pixels 631p, the plurality of scan lines G for selecting the pixels 631p row by row, and the plurality of signal lines S for supplying the S signals 633_S to the selected pixels 631p are provided in the pixel portion 631 divided into a plurality of regions (specifically, a first region 631a, a second region 631b, and a third region 631c).

The input of the G signals 632_G to the scan lines G in each region is controlled by the corresponding G driver circuit 632. The input of the S signals 633_S to the signal lines S is controlled by the S driver circuit 633. Each of the plurality of pixels 631p is connected to at least one of the scan lines G and at least one of the signal lines S.

Such a structure allows the pixel portion 631 to be divided into separately driven regions.

For example, the following operation is possible: when information is input from a touch panel used as the input unit 500, coordinates specifying a region to which the information is to be input are obtained, and the G driver circuit 632 driving the region corresponding to the coordinates operates in the first mode and the G driver circuit 632 driving the other region operates in the second mode. Thus, it is possible to stop the operation of the G driver circuit for a region where information has not been input from the touch panel, that is, a region where rewriting of a displayed image is not necessary.

### <2. G Driver Circuit in First Mode and Second Mode>

The S signal 633_S is input to the pixel circuit 634 to which the G signal 632_G output by the G driver circuit 632 is input. In a period during which the G signal 632_G is not input, the pixel circuit 634 holds the potential of the S signal 633_S. In other words, the pixel circuit 634 holds a state where the potential of the S signal 633_S is written in.

The pixel circuit 634 into which display data is written maintains a display state corresponding to the S signal 633_S, Note that to maintain a display state is to keep the amount of change in display state within a given range. This given range is set as appropriate, and is preferably set so that a user viewing displayed images can recognize the displayed images as the same image.

The G driver circuit 632 has the first mode and the second mode.

### <2-1. First Mode>

The G driver circuit 632 in the first mode outputs the G signals 632_G to pixels at a rate of higher than or equal to 30 times per second, preferably higher than or equal to 60 times per second and lower than 960 times per second.

The G driver circuit 632 in the first mode rewrites signals at a speed such that change in images which occurs each time signals are rewritten is not recognized by the user. As a result, a smooth moving image can be displayed.

### <2-2. Second Mode>

The G driver circuit 632 in the second mode outputs the G signals 632_G to pixels at a rate of higher than or equal to once per day and lower than 0.1 times per second, preferably higher than or equal to once per hour and lower than once per second.

In a period during which the G signal 632_G is not input, the pixel circuit 634 keeps holding the S signal 633_S and maintains the display state corresponding to the potential of the S signal 633_S.

In this manner, display without flicker due to rewriting of the display in the pixel can be performed in the second mode.

As a result, eye fatigue of a user of the liquid crystal display device having a display function can be reduced.

Power consumed by the G driver circuit 632 is reduced in a period during which the G driver circuit 632 does not operate.

Note that the pixel circuit that is driven by the G driver circuit 632 having the second mode is preferably configured to hold the S signal 633_S for a long period. For example, the off-state leakage current of the transistor 634t is preferably as low as possible.

Embodiments 8 and 9 can be referred to for examples of a structure of the transistor 634t with low off-state leakage current.

Note that this embodiment can be combined with any of the other embodiments in this specification as appropriate.

### Embodiment 4

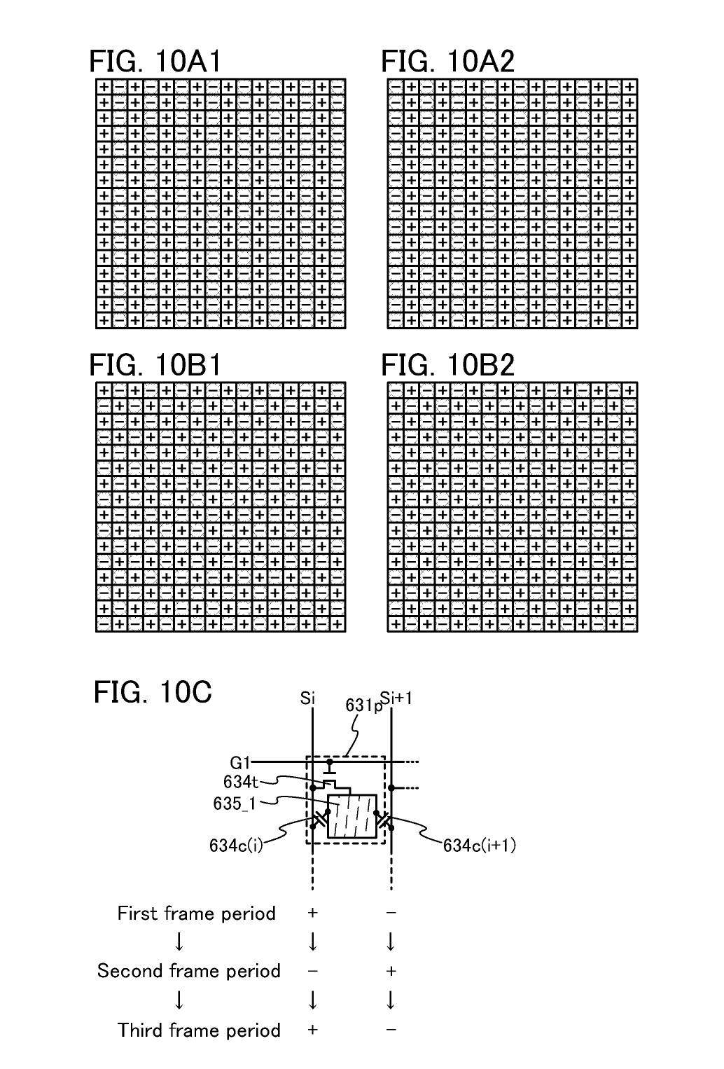

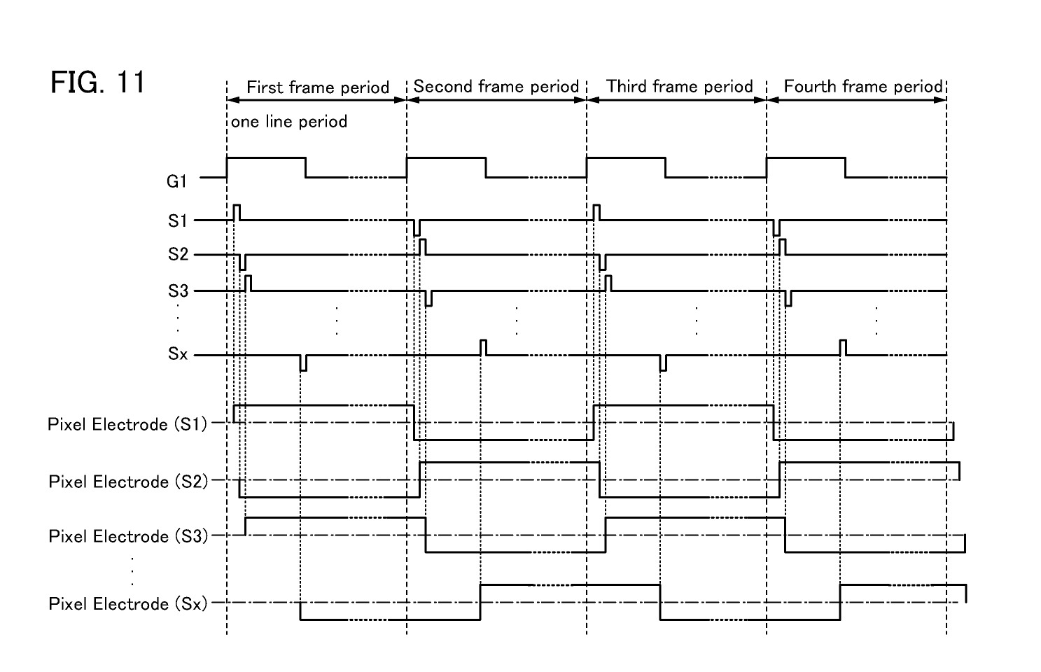

In this embodiment, an example of a method for driving the liquid crystal display device described in Embodiment 2 will be described with reference to FIG. 9, FIGS. 10A1, 10A2, 10B1, 10B2, and 10C, and FIG. 11.

FIG. 9 is a circuit diagram illustrating a liquid crystal display device having a display function in one embodiment of the present invention.

FIGS. 10A1, 10A2, 10B1, 10B2, and 10C illustrate source line inversion driving and dot line inversion driving of a liquid crystal display device having a display function in one embodiment of the present invention.

FIG. 11 is a timing chart illustrating source line inversion driving and dot line inversion driving of a liquid crystal display device having a display function in one embodiment of the present invention.

### <1. Overdriving>

Note that the response time of liquid crystal from application of voltage to saturation of the change in transmittance is generally about ten milliseconds. Thus, the slow response of the liquid crystal tends to be perceived as a blur of a moving image.

As a countermeasure, in one embodiment of the present invention, overdriving may be employed in which the voltage applied to the display element 635 including the liquid crystal element is temporarily increased so that the alignment of liquid crystal changes quickly. By overdriving, the response speed of the liquid crystal can be increased, a blur of a moving image can be prevented, and the quality of the moving image can be improved.

Further, if the transmittance of the display element 635 including the liquid crystal element keeps changing without reaching a constant value after the transistor 634t is turned off, the relative permittivity of the liquid crystal also changes; accordingly, the voltage held in the display element 635 including the liquid crystal element easily changes.

For example, in the case where no capacitor is connected in parallel to the display element 635 including the liquid crystal element or in the case where the capacitor 634c connected in parallel to the display element 635 including the liquid crystal element has small capacitance, the change in the voltage held in the display element 635 including the liquid crystal element tends to occur markedly. However, by the overdriving, the response time can be shortened and therefore the change in the transmittance of the display element 635 including the liquid crystal element after the transistor 634t is turned off can be made small. Accordingly, even in the case where the capacitor 634c connected in parallel to the display element 635 including the liquid crystal element has small capacitance, the change in the voltage held in the display element 635 including the liquid crystal element after turning off the transistor 634t can be prevented.

### <2. Source Line Inversion Driving and Dot Inversion Driving>

In the pixel 631p to which the signal line Si of the pixel circuit illustrated in FIG. 9 is connected, the pixel electrode 635_1 is positioned between the signal line Si and a signal line Si+1 that is adjacent to the signal line Si. If the transistor 634t is off, it is ideal that the pixel electrode 635_1 and the signal line Si are electrically separated from each other. Further, ideally, the pixel electrode 635_1 and the signal line Si+1 are electrically separated from each other. However, there actually exist a parasitic capacitance 634c(i) between the pixel electrode 635_1 and the signal line Si, and a parasitic capacitance 634c(i+1) between the pixel electrode 635_1 and the signal line Si+1 (see FIG. 10C). Note that FIG. 10C illustrates a pixel electrode 635_1 serving as a first electrode or a second electrode of the liquid crystal element 635LC, instead of the liquid crystal element 635LC illustrated in FIG. 9.

For example, when a structure is employed in which the first electrode and the second electrode of the liquid crystal element 635LC overlap with each other and the overlap between the two electrodes is practically utilized as a capacitor, there are cases where the capacitor 634c formed using a capacitor line is not connected to the liquid crystal element 635LC, or where the capacitor 634c connected to the liquid crystal element 635LC has a small capacitance. In such cases, the potential of the pixel electrode 635_1 serving as the first electrode or the second electrode of the liquid crystal element is easily affected by the parasitic capacitance 634c(i) and the parasitic capacitor 634c(i+1).

This tends to cause a phenomenon in which even when the transistor 634t is off in the period during which the potential of an image signal is held, the potential of the pixel electrode 635_1 fluctuates in conjunction with a change in the potential of the signal line Si or the signal line Si+1.

The phenomenon in which in the period during which the potential of an image signal is held, the potential of a pixel electrode fluctuates in conjunction with a change in the potential of a signal line is referred to as crosstalk. Crosstalk causes degradation of display contrast. For example, in the case of using normally-white liquid crystal for the liquid crystal element 635LC, images are whitish.

In one embodiment of the present invention, in view of the above situation, a driving method may be employed in which image signals having opposite polarities are input to the signal line Si and the signal line Si+1 arranged with the pixel electrode 635_1 provided therebetween, in one given frame period.

Note that the “image signals having opposite polarities” means, on the assumption that the potential of a common electrode of the liquid crystal element is a reference potential, an image signal having a potential higher than the reference potential and an image signal having a potential lower than the reference potential.

Two methods (source line inversion and dot inversion) can be given as examples of a method for sequentially writing image signals having alternating opposite polarities into a plurality of pixels which are selected.

In either method, in a first frame period, an image signal having a positive (+) polarity is input to the signal line Si and an image signal having a negative (−) polarity is input to the signal line Si+1. Next, in a second frame period, an image signal having a negative (−) polarity is input to the signal line Si and an image signal having a positive (+) polarity is input to the signal line Si+1. Then, in a third frame period, an image signal having a positive (+) polarity is input to the signal line Si and an image signal having a negative (−) polarity is input to the signal line Si+1 (see FIG. 10C).

When such a driving method is employed, the potentials of a pair of signal lines change in opposite polarity directions, whereby the fluctuation of the potential of a pixel electrode can be cancelled out. Therefore, crosstalk can be reduced.

### <2-1. Source Line Inversion Driving>

Source line inversion is a method in which image signals having opposite polarities are input in one given frame period so that the polarity of an image signal input to a plurality of pixels connected to one signal line and the polarity of an image signal input to a plurality of pixels connected to another signal line that is adjacent to the above signal line are opposite to each other.

FIGS. 10A1 and 10A2 schematically show polarities of image signals supplied to pixels in the case of source line inversion driving. In FIGS. 10A1 and 10A2, the sign “+” indicates a pixel to which an image signal having a positive polarity is supplied in one given frame period, and the sign “−” indicates a pixel to which an image signal having a negative polarity is supplied in the given frame period. The frame illustrated in FIG. 10A2 is a frame following the frame illustrated in FIG. 10A1.

### <2-2. Dot Inversion Driving>

Dot inversion is a method in which image signals having opposite polarities are input in one given frame period so that the polarity of an image signal input to a plurality of pixels connected to one signal line and the polarity of an image signal input to a plurality of pixels connected to another signal line adjacent to the above signal line are opposite to each other and, in addition, so that in the plurality of pixels connected to the one signal line, the polarity of an image signal input to a pixel and the polarity of an image signal input to a pixel adjacent to the pixel are opposite to each other.

FIGS. 10B1 and 10B2 schematically show polarities of image signals supplied to pixels in the case of dot inversion driving. In FIGS. 10B1 and 10B2, the sign “+” indicates a pixel to which an image signal having a positive polarity is supplied in one given frame period, and the sign “−” indicates a pixel to which an image signal having a negative polarity is supplied in the given frame period. The frame illustrated in FIG. 10B2 is a frame following the frame illustrated in FIG. 10B1.

### <2-3. Timing Chart>

FIG. 11 is a timing chart in the case of operating the pixel portion 631 illustrated in FIG. 9 by source line inversion driving. Specifically, FIG. 11 shows changes over time of the potential of a signal supplied to the scan line G1, the potentials of image signals supplied to the signal lines S1 to Sx, and the potentials of the pixel electrodes included in pixels connected to the scan line G1.

First, the scan line G1 is selected by inputting a signal with a pulse to the scan line G1. In each of the plurality of pixels 631p connected to the selected scan line G1, the transistor 634t is turned on. When a potential of an image signal is supplied to the signal lines S1 to Sx in the state where the transistor 634t is on, the potential of the image signal is supplied to the pixel electrode of the liquid crystal element 635LC via the on-state transistor 634t.

In the timing chart of FIG. 11, an example is shown in which, in a period during which the scan line G1 is selected in the first frame period, image signals having a positive polarity are sequentially input to the odd-numbered signal lines S1, S3, . . . and image signals having a negative polarity are sequentially input to the even-numbered signal lines S2, S4, . . . , Sx. Therefore, image signals having a positive polarity are supplied to the pixel electrodes (S1), (S3), . . . in the pixels 631p which are connected to the odd-numbered signal lines S1, S3, . . . . Further, image signals having a negative polarity are supplied to the pixel electrodes (S2), (S4), . . . , (Sx) in the pixels 631p connected to the even-numbered signal lines S2, S4, . . . , Sx.

In the liquid crystal element 635LC, the alignment of liquid crystal molecules is changed in accordance with the level of the voltage applied between the pixel electrode and the common electrode, whereby transmittance is changed. Accordingly, the transmittance of the liquid crystal element 635LC can be controlled by the potential of the image signal; thus, gradation can be displayed.

When input of image signals to the signal lines S1 to Sx is completed, the selection of the scan line G1 is terminated. When the selection of the scan line is terminated, the transistors 634t are turned off in the pixels 631p connected to the scan line. Then, voltage applied between the pixel electrode and the common electrode is held in the liquid crystal element 635LC, whereby display of gradation is maintained. Further, the scan lines G2 to Gy are sequentially selected, and operations similar to that in the period during which the scan line G1 is selected are performed in the pixels connected to the above respective scan lines.

Next, the scan line G1 is selected again in the second frame period. In a period during which the scan line G1 is selected in the second frame period, image signals having a negative polarity are sequentially input to the odd-numbered signal lines S1, S3, . . . and image signals having a positive polarity are sequentially input to the even-numbered signal lines S2, S4, . . . , Sx, unlike the period during which the scan line G1 is selected in the first frame period. Therefore, image signals having a negative polarity are supplied to the pixel electrodes (S1), (S3), . . . in the pixels 631p which are connected to the odd-numbered signal lines S1, S3, . . . Further, image signals having a positive polarity are supplied to the pixel electrodes (S2), (S4), . . . , (Sx) in the pixels 631p connected to the even-numbered signal lines S2, S4, . . . , Sx.

Also in the second frame period, when input of image signals to the signal lines S1 to Sx is completed, the selection of the scan line G1 is terminated. Further, the scan lines G2 to Gy are sequentially selected, and operations similar to that in the period during which the scan line G1 is selected are performed in the pixels connected to the above respective scan lines.

An operation similar to the above is repeated in the third frame period and the fourth frame period.

Although an example in which image signals are sequentially input to the signal lines S1 to Sx is shown in the timing chart of FIG. 11, one embodiment of the present invention is not limited to this structure. Image signals may be input to the signal lines S1 to Sx all at once, or image signals may be sequentially input per plurality of signal lines.

In this embodiment, the scan line is selected by progressive scan; however, interlace scan may also be employed for selecting a scan line.

By inversion driving in which the polarity of the potential of an image signal is inverted using the reference potential of a common electrode as a reference, degradation of liquid crystal called burn-in can be prevented.

However, in the inversion driving, the change in the potential supplied to the signal line is increased at the time of changing the polarity of the image signal; thus, a potential difference between a source electrode and a drain electrode of the transistor 634t which functions as a switching element is increased. Accordingly, degradation of characteristics, such as a shift of threshold voltage, is easily caused in the transistor 634t.

Furthermore, in order to maintain the voltage held in the liquid crystal element 635LC, the off-state current of the transistor 634t needs to be low even when the potential difference between the source electrode and the drain electrode is large.

Note that this embodiment can be combined with any of the other embodiments in this specification as appropriate.

### Embodiment 5

In this embodiment, description is made on a method for generating an image that can be displayed on the liquid crystal display device of one embodiment of the present invention. In particular, an eye-friendly image switching method is described. The eye-friendly image switching method includes an image switching method by which eye strain of users is reduced and an image switching method by which the eye strain is not caused.

High-speed image switching causes eye strain of users in some cases. For example, moving image display for which images are switched at an extremely high speed and the case of switching between different still images correspond to the high-speed image switching.

When images are switched for displaying different images, it is preferable that the images be switched gradually (silently) and naturally, not instantaneously.

For example, when a first image is changed to a second image that is different from the first image, it is preferable to interpose a fade-out image of the first image and/or a fade-in image of the second image between the first image and the second image. Alternatively, an image obtained by overlapping the first image and the second image may be interposed so that the second image fades in at the same time when the first image fades out (this technique is also referred to as crossfading). Further alternatively, a moving image (also referred to as morphing) for displaying the process in which the first image gradually changes into the second image may be interposed.

Specifically, a first still image is displayed at a low refresh rate, followed by an image for image switching is displayed at a high refresh rate, and then a second still image is displayed at a low refresh rate.

### <Fade-in, Fade-out>

An example of a method for switching images A and B which are different images is described below.

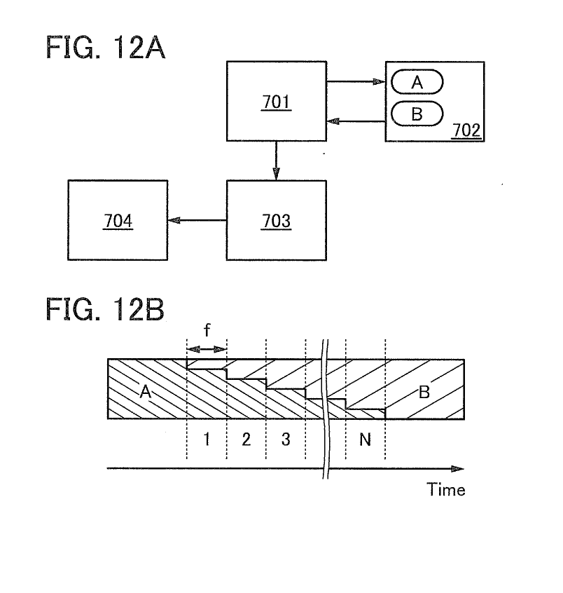

FIGS. 12A and 12B are block diagrams of a structure of a display device capable of switching images. The display device illustrated in FIG. 12A includes an arithmetic unit 701, a memory unit 702, a graphic unit 703, and a display means 704.

In the first step, the arithmetic unit 701 makes the memory unit 702 store data for the image A and data for the image B from an external memory device or the like.

In the second step, the arithmetic unit 701 sequentially generates new image data on the basis of the data for the image A and the data for the image B, in accordance with a division number set in advance.

In the third step, the arithmetic unit 701 outputs the generated image data to the graphic unit 703. The graphic unit 703 makes the display means 704 display the image data.

FIG. 12B is a schematic view for explaining image data generated for gradual image switching from the image A to the image B.

FIG. 12B shows the case where N(N is a natural number) sets of image data are generated for switching from the image A to the image B, and each set of image data is displayed for a frame period off Os a natural number). Therefore, the period needed for the switching from the image A to the image B is f×N.

Here, it is preferable that the above parameters such as N and f can be set freely by users. The arithmetic unit 701 obtains these parameters in advance, and generates image data in accordance with the parameters.

The i-th generated image data (i is an integer of 1 or larger and N or smaller) is generated by weighting image data of the image A and image data of the image B and summing up the weighted data. For example, when the luminance (gray level) of a certain pixel where the image A is displayed is represented by a and the luminance (gray level) of the pixel where the image B is displayed is represented by b, the luminance (gray level) c of the pixel where the i-th generated image data is displayed is expressed by Formula 1.

$$c = \frac{( N + 1 - i ) a + ib}{N + 1} \qquad [ FORMULA 1 ]$$

The image A is changed to the image B using image data generated in the above manner; therefore, discontinuous images can be switched gradually (silently) and naturally.

The case when all pixels satisfy a=0 in Formula I corresponds to fade-in when a black image is gradually changed to the image B. The case when all pixels satisfy b=0 corresponds to fade-out when the image A is gradually changed to the black image.

Although the method for switching images by temporarily overlapping two images is described above, a method by which images are not overlapped may be employed.

In the case where two images are not overlapped with each other, a black image may be interposed between the image A and the image B. In this case, the above image switching method can be performed at transition from the image A to the black image and/or transition from the black image to the image B. Moreover, an image interposed between the image A and the image B is not necessarily limited to a black image; a single color image like a white image may be used, or a multicolored image may be used as long as it differs from the image A and the image B.

Interposition of another image, particularly a single color image like a black image, between the image A and the image B enables users to watch images without feeling uncomfortable even when the images are switched; that is, images can be switched without causing stress of users.

### Embodiment 6

In this embodiment, a structural example of a panel module which can be used as a display unit in a liquid crystal display device of one embodiment of the present invention is described with reference to drawings.

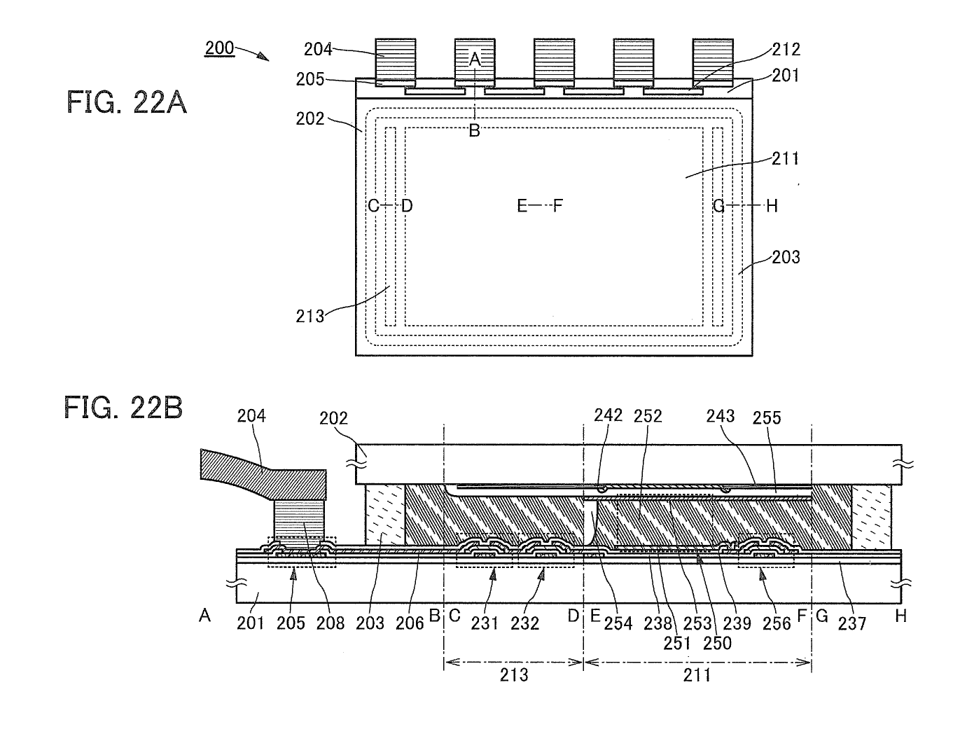

FIG. 22A is a schematic top view of a panel module 200 described as an example in this embodiment.

The panel module 200 includes a pixel portion 211 including a plurality of pixels and a gate driver circuit 213 in a sealed region surrounded by a first substrate 201, a second substrate 202, and a sealant 203. The panel module 200 also includes an external connection electrode 205 and an IC 212 functioning as a source driver circuit in a region outside the sealed region over the first substrate 201. Power and signals for driving the pixel portion 211, the gate driver circuit 213, the IC 212, and the like can be input through an FPC 204 electrically connected to the external connection electrode 205.

FIG. 22B is a schematic cross-sectional view of a region including the FPC 204 and the sealant 203 along the section line A-B, a region including the gate driver circuit 213 along the section line C-D, a region including the pixel portion 211 along the section line E-F, and a region including the sealant 203 along the section line G-H in FIG. 22A.

The first substrate 201 and the second substrate 202 are bonded to each other with the sealant 203 in regions of the substrates which are close to the outer edges. In a region surrounded by the first substrate 201, the second substrate 202, and the sealant 203, at least the pixel portion 211 is provided.

In FIG. 22B, the gate driver circuit 213 includes a circuit in which n-channel transistors, transistors 231 and 232, are used in combination, as an example. Note that the gate driver circuit 213 is not limited to this structure and may include various

CMOS circuits in which an n-channel transistor and a p-channel transistor are used in combination or a circuit in which p-channel transistors are used in combination. Although a driver-integrated structure in which the gate driver circuit 213 is formed over the first substrate 201 is described in this structural example, the gate driver circuit or the source driver circuit, or both may be formed over a substrate different from the first substrate 201. For example, a driver circuit IC may be mounted by a COG method, or a flexible substrate (FPC) mounted with a driver circuit IC by a COF method may be mounted. In this structural example, the IC 212 functioning as a source driver circuit is provided over the first substrate 201 by a COG method.

Note that there is no particular limitation on the structures of the transistors included in the pixel portion 211 and the gate driver circuit 213. For example, a forward staggered transistor or an inverted staggered transistor may be used. Further, a top-gate transistor or a bottom-gate transistor may be used. As a semiconductor material used for the transistors, for example, a semiconductor material such as silicon or germanium or an oxide semiconductor containing at least one of indium, gallium, and zinc may be used.

Further, there is no particular limitation on the crystallinity of a semiconductor used for the transistors, and an amorphous semiconductor or a semiconductor having crystallinity (a microcrystalline semiconductor, a polycrystalline semiconductor, a single crystal semiconductor, or a semiconductor partly including crystal regions) may be used. A semiconductor having crystallinity is preferably used, in which case deterioration of transistor characteristics can be reduced.

Typical examples of the oxide semiconductor containing at least one of indium, gallium, and zinc include an In—Ga—Zn-based metal oxide. An oxide semiconductor having a wider band gap and a lower carrier density than silicon is preferably used because off-state leakage current can be reduced. Details of preferred oxide semiconductors will be described below in Embodiments 8 and 9.

FIG. 22B shows a cross-sectional structure of one pixel as an example of the pixel portion 211. The pixel portion 211 includes a liquid crystal element 250 using a vertical alignment (VA) mode.

One pixel includes at least a switching transistor 256 and may also include a storage capacitor which is not shown. In addition, a first electrode 251 is provided over an insulating layer 239 to be electrically connected to a source electrode or a drain electrode of the transistor 256.

The liquid crystal element 250 provided for a pixel includes the first electrode 251 provided over the insulating layer 239, a second electrode 253 provided on the second substrate 202, and a liquid crystal 252 sandwiched between the first electrode 251 and the second electrode 253.

For the first electrode 251 and the second electrode 253, a light-transmitting conductive material is used. As the light-transmitting conductive material, a conductive oxide such as indium oxide, indium tin oxide, indium zinc oxide, zinc oxide, or zinc oxide to which gallium is added, or graphene can be used.

Further, a color filter 243 and a black matrix 242 are provided on the second substrate 202 in at least a region overlapping with the pixel portion 211.

The color filter 243 is provided in order to adjust the color of light transmitted through a pixel to increase the color purity. For example, in a full-color panel module using a white backlight, a plurality of pixels provided with color filters of different colors is used. In that case, the color filters may be those of three colors of R (red), G (green), and B (blue) or four colors (yellow (Y) in addition to these three colors). Further, a white (W) pixel may be added to R, G, and B pixels (and a Y pixel). That is, color filters of four colors (or five colors) may be used.

A black matrix 242 is provided between the adjacent color filters 243. The black matrix 242 blocks light emitted from an adjacent pixel, thereby preventing color mixture between the adjacent pixels. In one configuration, the black matrix 242 may be provided only between adjacent pixels of different emission colors and not between pixels of the same emission color. Here, the color filter 243 is provided so that its end portions overlap with the black matrix 242, whereby light leakage can be reduced. The black matrix 242 can be formed using a material that blocks light transmitted through the pixel, for example, a metal material or a resin material including a pigment. Note that it is preferable to provide the black matrix 242 also in a region overlapping with the gate driver circuit 213 or the like besides the pixel portion 211 as illustrated in FIGS. 22A and 22B, in which case undesired leakage of guided light or the like can be prevented.

An overcoat 255 is provided so as to cover the color filter 243 and the black matrix 242. The overcoat 255 can suppress diffusion of impurities such as a pigment, which are included in the color filter 243 and the black matrix 242, into the liquid crystal 252. For the overcoat, a light-transmitting material is used, and an inorganic insulating material or an organic insulating material can be used.

Note that the second electrode 253 is provided on the overcoat 255.

In addition, a spacer 254 is provided in a region where the overcoat 255 overlaps with the black matrix 242. The spacer 254 is preferably formed using a resin material because it can be formed thick. For example, the spacer 254 can be formed using a positive or negative photosensitive resin. When a light-blocking material is used for the spacer 254, the spacer 254 blocks light emitted from an adjacent pixel, thereby preventing color mixture between the adjacent pixels. Although the spacer 254 is provided on the second substrate 202 side in this structural example, the spacer 254 may be provided on the first substrate 201 side. Further, a structure may be employed in which spherical silicon oxide particles are used as the spacer 254 and the particles are scattered in a region where the liquid crystal 252 is provided.

An image can be displayed in the following way: an electric field is generated in the vertical direction with respect to an electrode surface by application of voltage between the first electrode 251 and the second electrode 253, alignment of the liquid crystal 252 is controlled by the electric field, and polarization of light from a backlight provided outside the panel module is controlled in each pixel.

An alignment film that controls alignment of the liquid crystal 252 may be provided on a surface in contact with the liquid crystal 252. A light-transmitting material is used for the alignment film.

In this structural example, a color filter is provided in a region overlapping with the liquid crystal element 250; thus, a full-color image with high color purity can be displayed. With the use of a plurality of light-emitting diodes (LEDs) which emit light of different colors as a backlight, a time-division display method (a field-sequential driving method) can be employed. In the case of employing a time-division display method, the aperture ratio of each pixel or the number of pixels per unit area can be increased because neither color filters nor subpixels from which light of red (R), green (G), or blue (B), for example, is obtained are needed.

As the liquid crystal 252, a thermotropic liquid crystal, a low-molecular liquid crystal, a polymer liquid crystal, a ferroelectric liquid crystal, an anti-ferroelectric liquid crystal, or the like can be used. Moreover, a liquid crystal exhibiting a blue phase is preferably used because an alignment film is not needed and a wide viewing angle is obtained in that case. It is also possible to use a polymer-stabilized liquid crystal material which is obtained by adding a monomer and a polymerization initiator to the above liquid crystal and, after injection or dispensing and sealing of the liquid crystal, polymerizing the monomer.

Although the liquid crystal element 250 using a VA mode is described in this structural example, the structure of the liquid crystal element is not limited to this example, and the liquid crystal element 250 using a different mode can be used.

The first substrate 201 is provided with an insulating layer 237 in contact with an upper surface of the first substrate 201, an insulating layer 238 functioning as a gate insulating layer of transistors, and the insulating layer 239 covering the transistors.

The insulating layer 237 is provided in order to prevent diffusion of impurities included in the first substrate 201. The insulating layers 238 and 239, which are in contact with semiconductor layers of the transistors, are preferably formed using a material which prevents diffusion of impurities that promote degradation of the transistors. For these insulating layers, for example, an oxide, a nitride, or an oxynitride of a semiconductor such as silicon or a metal such as aluminum can be used. Alternatively, a stack of such inorganic insulating materials or a stack of such an inorganic insulating material and an organic insulating material may be used. Note that the insulating layers 237 and 239 are not necessarily provided when not needed.

An insulating layer functioning as a planarization layer which covers steps due to the transistors, a wiring, or the like provided therebelow may be provided between the insulating layer 239 and the first electrode 251. For such an insulating layer, it is preferable to use a resin material such as polyimide or acrylic. An inorganic insulating material may be used as long as high planarity can be obtained.

With the structure shown in FIG. 22B, the number of photomasks needed for forming a transistor and the first electrode 251 of the liquid crystal element 250 over the first substrate 201 can be reduced. Specifically, five photomasks are needed; one is used in a step of processing a gate electrode, one is used in a step of processing a semiconductor layer, one is used in a step of processing a source electrode and a drain electrode, one is used in a step of forming an opening in the insulating layer 239, and one is used in a step of processing the first electrode 251.

A wiring 206 over the first substrate 201 is provided so as to extend to the outside of the region sealed with the sealant 203 and is electrically connected to the gate driver circuit 213. Part of an end portion of the wiring 206 forms part of the external connection electrode 205. In this structural example, the external connection electrode 205 is formed by a stack of a conductive film used for the source electrode and the drain electrode of the transistor and a conductive film used for the gate electrode of the transistor. The external connection electrode 205 is preferably formed by a stack of a plurality of conductive films as described above because mechanical strength against a pressure bonding step performed on the FPC 204 or the like can be increased.

Although not shown, a wiring and an external connection electrode which electrically connect the IC 212 and the pixel portion 211 may have structures similar to those of the wiring 206 and the external connection electrode 205.

A connection layer 208 is provided in contact with the external connection electrode 205. The FPC 204 is electrically connected to the external connection electrode 205 through the connection layer 208. For the connection layer 208, a variety of anisotropic conductive films, a variety of anisotropic conductive pastes, or the like can be used.

The end portions of the wiring 206 and the external connection electrode 205 are preferably covered with an insulating layer so that surfaces thereof are not exposed, in which case oxidation of the surfaces and defects such as an unintended short circuit can be suppressed.

This embodiment can be combined with any of the other embodiments disclosed in this specification as appropriate.

### Embodiment 7

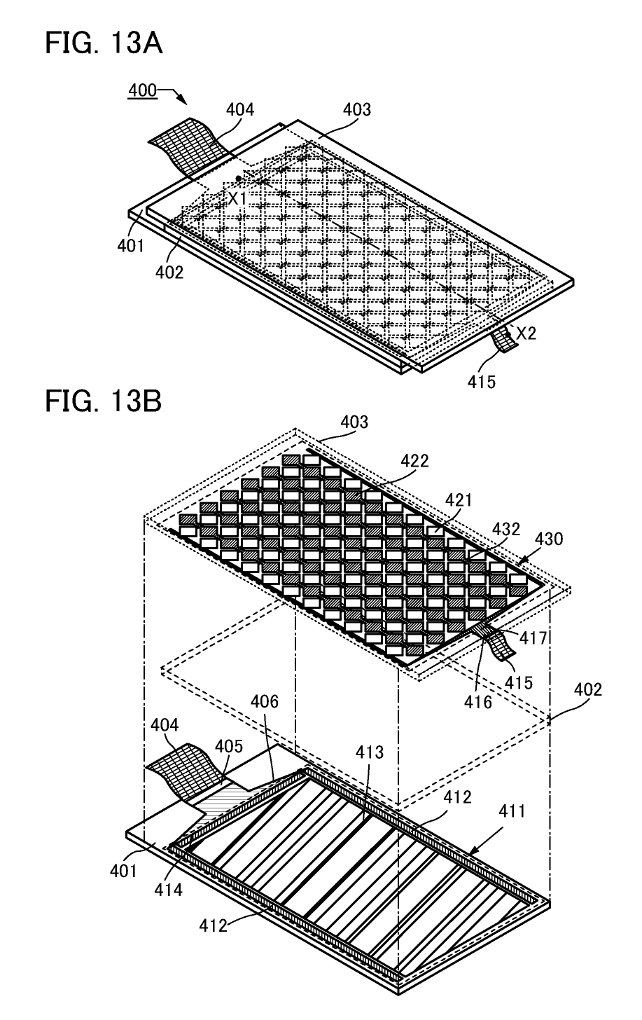

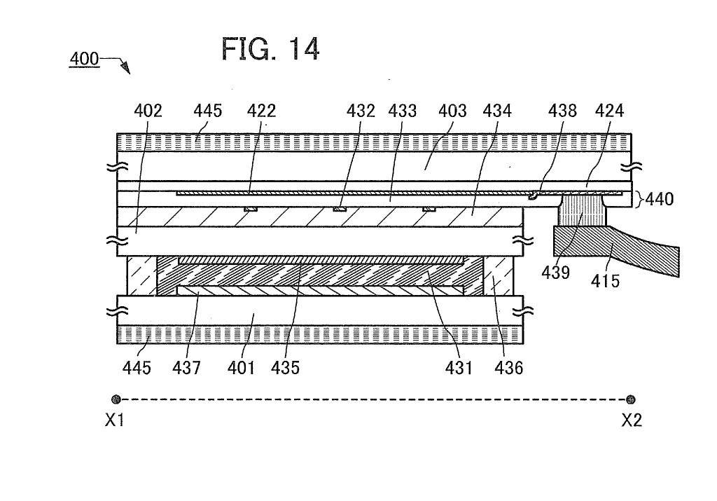

The panel module described in Embodiment 6 can function as a touch panel by being provided with a touch sensor (a contact detector). In this embodiment, a touch panel and a liquid crystal module including the touch panel will be described with reference to FIGS. 13A and 13B and FIG. 14. Hereinafter, description of the same portions as those in the above embodiment is omitted in some cases.

FIG. 13A is a perspective schematic diagram of a liquid crystal module 400 including a touch panel shown in this embodiment. Note that FIGS. 13A and 13B illustrate only major components for simplicity. FIG. 13B is a developed view of the schematic perspective view of the touch panel.

The liquid crystal module 400 including the touch panel includes a display portion 411 sandwiched between a first substrate 401 and a second substrate 402, and a touch sensor 430 sandwiched between the second substrate 402 and a third substrate 403.

The first substrate 401 is provided with the display portion 411 and a plurality of wirings 406 electrically connected to the display portion 411. The plurality of wirings 406 is led to the periphery of the first substrate 401, and some of the wirings form part of an external connection electrode 405 for electrical connection to an FPC 404.

The display portion 411 includes a pixel portion 414 including a plurality of pixels, a source driver circuit 412, and a gate driver circuit 413, and sealed by the first substrate 401 and the second substrate 402. Although FIG. 13B illustrates a structure in which two source driver circuits 412 are positioned on both sides of the pixel portion 414, one source driver circuit 412 may be positioned along one side of the pixel portion 414.

As a display element that can be used in the pixel portion 414 of the display portion 411, any of a variety of display elements such as an organic EL element, a liquid crystal element, and a display element performing display with electrophoresis, electronic liquid powder, or the like can be used. In this embodiment, a liquid crystal element is used as the display element.

The third substrate 403 is provided with the touch sensor 430 and a plurality of wirings 417 electrically connected to the touch sensor 430. The touch sensor 430 is provided on a surface of the third substrate 403 on a side facing the second substrate 402. The plurality of wirings 417 is led to the periphery of the third substrate 403, and some of the wirings form part of an external connection electrode 416 for electrical connection to an FPC 415. Note that in FIG. 13B, electrodes, wirings, and the like of the touch sensor 430 which are provided on the back side of the third substrate 403 (the back side of the diagram) are indicated by solid lines for clarity.

The touch sensor 430 illustrated in FIG. 13B is an example of a projected capacitive touch sensor. The touch sensor 430 includes electrodes 421 and electrodes 422. The electrode 421 and the electrode 422 are each electrically connected to any one of the plurality of wirings 417.

Here, the electrode 422 is in the form of a series of quadrangles arranged in one direction as illustrated in FIGS. 13A and 13B. Each of the electrodes 421 is in the form of a quadrangle. The plurality of electrodes 421 arranged in a line in a direction intersecting with the direction in which the electrode 422 extends is electrically connected to each other by a wiring 432. The electrode 422 and the wiring 432 are preferably arranged so that the area of the intersecting portion of the electrode 422 and the wiring 432 becomes as small as possible. Such a shape can reduce the area of a region where the electrodes are not provided and decrease luminance unevenness of light passing through the touch sensor 430 which are caused by a difference in transmittance depending on whether the electrodes are provided or not.

Note that the shapes of the electrode 421 and the electrode 422 are not limited thereto and can be any of a variety of shapes. For example, a structure may be employed in which the plurality of electrodes 421 is arranged so that gaps between the electrodes 421 are reduced as much as possible, and the electrode 422 is spaced apart from the electrodes 421 with an insulating layer interposed therebetween to have regions not overlapping with the electrodes 421. In that case, between two adjacent electrodes 422, it is preferable to provide a dummy electrode which is electrically insulated from these electrodes, whereby the area of regions having different transmittances can be reduced.

FIG. 14 is a cross-sectional view of the liquid crystal module 400 including the touch panel in FIGS. 13A and 13B taken along X1-X2.

A switching element layer 437 is provided over the first substrate 401. The switching element layer 437 includes at least a transistor, and may further include a capacitor or the like. Furthermore, the switching element layer 437 may include a driver circuit (a gate driver circuit and/or a source driver circuit), a wiring, an electrode, or the like.

A color filter layer 435 is provided on one surface of the second substrate 402. The color filter layer 435 includes a color filter which overlaps with a liquid crystal element. When the color filter layer 435 is provided with three color filters of red (R), green (G), and blue (B), a full-color liquid crystal display device can be obtained.

The color filter layer 435 can be formed using a photosensitive material including a pigment by a photolithography process. As the color filter layer 435, a black matrix may be provided between color filters with different colors. Furthermore, an overcoat may be provided to cover the color filters and the black matrix.

Note that one of electrodes of the liquid crystal element may be formed on the color filter layer 435 in accordance with the structure of the liquid crystal element. Note that the electrode becomes part of the liquid crystal element to be formed later. An alignment film may be provided over the electrode.

A liquid crystal 431 is sealed between the first substrate 401 and the second substrate 402 with a sealant 436. The sealant 436 is provided to surround the switching element layer 437 and the color filter layer 435.

As the sealant 436, a thermosetting resin or an ultraviolet curable resin can be used; for example, an organic resin such as an acrylic resin, an urethane resin, an epoxy resin, or a resin having a siloxane bond can be used. Alternatively, the sealant 436 may be formed with glass frit including a low-melting-point glass. Further alternatively, the sealant 436 may be formed with a combination of the organic resin and the glass frit. For example, a structure in which the organic resin is provided in contact with the liquid crystal 431 and the glass frit is provided outside the liquid crystal 431 can prevent water and the like from entering the liquid crystal from the outside.

A touch sensor is provided over the second substrate 402. In the touch sensor, a sensor layer 440 is provided on one surface of the third substrate 403 with an insulating layer 424 provided therebetween. The sensor layer 440 is bonded to the second substrate 402 with an adhesive layer 434 provided therebetween. A polarizing plate 441 is provided on the other surface of the third substrate 403.

The touch sensor can be formed over the liquid crystal display device 420 as follows: the sensor layer 440 is formed over the third substrate 403; and the sensor layer 440 is bonded to the second substrate 402 with the adhesive layer 434 that is over the sensor layer 440, interposed therebetween.

For the insulating layer 424, an oxide such as a silicon oxide can be used. Electrodes 421 having a light-transmitting property and electrodes 422 having a light-transmitting property are provided in contact with the insulating layer 424. The electrodes 421 and the electrodes 422 are formed in the following manner: a conductive film is formed over the insulating layer 424 over the third substrate 403 by a sputtering method, and selectively etched by a variety of patterning technique such as a photolithography process. As a light-transmitting conductive material, a conductive oxide such as indium oxide, indium tin oxide, indium zinc oxide, zinc oxide, or zinc oxide to which gallium is added can be used.

A wiring 438 is electrically connected to the electrode 421 or the electrode 422. Part of the wiring 438 serves as an external connection electrode which is electrically connected to the FPC 415. For the wiring 438, a metal material such as aluminum, gold, platinum, silver, nickel, titanium, tungsten, chromium, molybdenum, iron, cobalt, copper, or palladium or an alloy material containing any of these metal materials can be used.

The electrodes 422 are provided to form stripes extended in one direction. The electrodes 421 are provided such that one electrode 422 is sandwiched between a pair of electrodes 421. The wiring 432 that electrically connects the electrodes 421 is provided to cross the electrode 422. Here, the one electrode 422 and a plurality of electrodes 421 which are electrically connected to each other by the wiring 432 do not necessarily intersect orthogonally and may form an angle of less than 90°.

An insulating layer 433 is provided to cover the electrodes 421 and the electrodes 422. As a material of the insulating layer 433, for example, a resin such as acrylic or epoxy, a resin having a siloxane bond, or an inorganic insulating material such as silicon oxide, silicon oxynitride, or aluminum oxide can be used. Openings reaching the electrodes 421 are formed in the insulating layer 433, and the wirings 432 electrically connected to the electrodes 421 are provided over the insulating layer 433 and in the openings. The wiring 432 is preferably formed using a light-transmitting conductive material similar to that of the electrode 421 and the electrode 422, in which case the aperture ratio of the touch panel can be improved. Although a material which is the same as that of the electrode 421 and the electrode 422 may be used for the wiring 432, a material having higher conductivity than the material of the electrode 421 and the electrode 422 is preferably used for the wiring 432.

An insulating layer covering the insulating layer 433 and the wirings 432 may be provided. The insulating layer can serve as a protection layer.

An opening reaching the wiring 438 is formed in the insulating layer 433 (and the insulating layer serving as a protection layer). A connection layer 439 provided in the opening electrically connects the FPC 415 with the wiring 438. For the connection layer 439, a variety of anisotropic conductive films (ACF), anisotropic conductive pastes (ACP), or the like can be used.

It is preferable that the adhesive layer 434 by which the sensor layer 440 is bonded to the second substrate 402 have a light-transmitting property. For example, a thermosetting resin or an ultraviolet curable resin can be used; specifically, a resin such as an acrylic resin, an urethane resin, an epoxy resin, or a resin having a siloxane bond can be used.

As the polarizing plate 441, a variety of polarizing plates can be used. For the polarizing plate 441, a material capable of producing linearly polarized light from natural light or circularly polarized light is used. For example, a material whose optical anisotropy is obtained by disposing dichroic substances in one direction can be used. Such a polarizing plate can be formed in such a manner that an iodine-based compound or the like is adsorbed to a film such as a polyvinyl alcohol film and the film or the like is stretched in one direction, for example. Note that as the dichroic substance, a dye-based compound or the like as well as an iodine-based compound can be used. A film-like, sheet-like, or plate-like material can be used for the polarizing plate 441.

Note that in this embodiment, an example is described in which a projected capacitive touch sensor is used for the sensor layer 440; however, the sensor layer 440 is not limited to this, and a sensor functioning as a touch sensor which senses proximity or touch of a conductive object to be sensed such as a finger from an outer side than the polarizing plate can be used. The touch sensor provided in the sensor layer 440 is preferably a capacitive touch sensor. Examples of the capacitive touch sensor are of a surface capacitive type, of a projected capacitive type, and the like. Further, examples of the projected capacitive type are of a self-capacitive type, a mutual capacitive type, and the like mainly in accordance with the difference in the driving method. The use of a mutual capacitive type is preferable because multiple points can be sensed simultaneously.

In the touch panel and the liquid crystal module including the touch panel which are described in this embodiment, since the refresh rate at the time of still image display can be reduced, the same image can be seen for a long time by users as much as possible; thus, perceivable flickers in a screen can be reduced. Furthermore, the size of one pixel is small and thus high resolution display is possible, so that precise and smooth display can be achieved. Moreover, at the time of still image display, deterioration of image quality caused by a change in gray level can be reduced and power consumed by the touch panel can be reduced. Note that the liquid crystal module including a touch panel may be what is called an in-cell module.

### Embodiment 8

In this embodiment, structural examples of transistors which can be used in pixels of a liquid crystal display device will be described with reference to drawings.

### Structure Example of Transistor

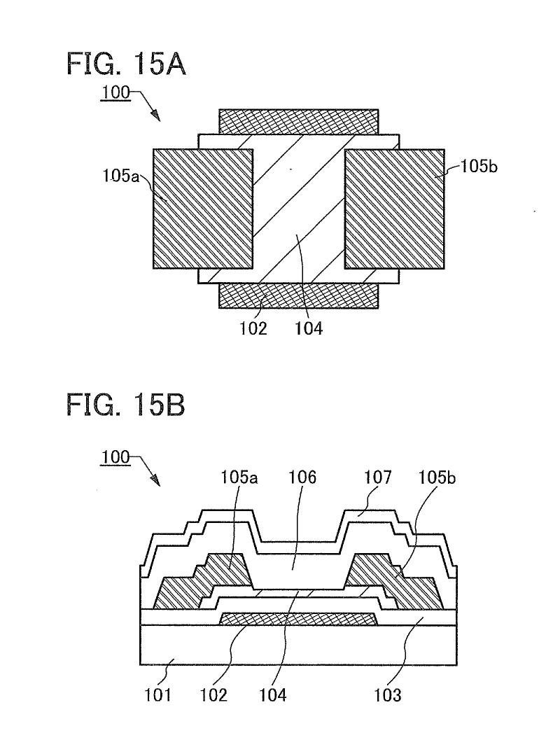

FIG. 15A is a schematic top view of a transistor 100 described below as an example. FIG. 15B is a schematic cross-sectional view of the transistor 100 taken along the section line A-B in FIG. 15A. The transistor 100 described as an example in this structure example is a bottom-gate transistor.

The transistor 100 includes a gate electrode 102 over a substrate 101, an insulating layer 103 over the substrate 101 and the gate electrode 102, an oxide semiconductor layer 104 over the insulating layer 103, which overlaps with the gate electrode 102, and a pair of electrodes 105a and 105b in contact with the top surface of the oxide semiconductor layer 104. Further, an insulating layer 106 is provided to cover the insulating layer 103, the oxide semiconductor layer 104, and the pair of electrodes 105a and 105b, and an insulating layer 107 is provided over the insulating layer 106.

### <<Substrate 101>>

There is no particular limitation on the property of a material and the like of the substrate 101 as long as the material has heat resistance enough to withstand at least heat treatment which will be performed later. For example, a glass substrate, a ceramic substrate, a quartz substrate, a sapphire substrate, or an yttria-stabilized zirconia (YSZ) substrate may be used as the substrate 101. Alternatively, a single crystal semiconductor substrate or a polycrystalline semiconductor substrate made of silicon, silicon carbide, or the like, a compound semiconductor substrate made of silicon germanium or the like, an SOI substrate, or the like can be used as the substrate 101. Still alternatively, any of these substrates provided with a semiconductor element may be used as the substrate 101.

Still alternatively, a flexible substrate such as a plastic substrate may be used as the substrate 101, and the transistor 100 may be provided directly on the flexible substrate. Further alternatively, a separation layer may be provided between the substrate 101 and the transistor 100. The separation layer can be used when part or the whole of the transistor formed over the separation layer is formed and separated from the substrate 101 and transferred to another substrate. Thus, the transistor 100 can be transferred to a substrate having low heat resistance or a flexible substrate.

### <<Gate Electrode 102>>

The gate electrode 102 can be formed using a metal selected from aluminum, chromium, copper, tantalum, titanium, molybdenum, and tungsten; an alloy containing any of these metals as a component; an alloy containing any of these metals in combination; or the like. Further, one or more metals selected from manganese and zirconium may be used. Furthermore, the gate electrode 102 may have a single-layer structure or a stacked-layer structure of two or more layers. For example, a single-layer structure of an aluminum film containing silicon, a two-layer structure in which a titanium film is stacked over an aluminum film, a two-layer structure in which a titanium film is stacked over a titanium nitride film, a two-layer structure in which a tungsten film is stacked over a titanium nitride film, a two-layer structure in which a tungsten film is stacked over a tantalum nitride film or a tungsten nitride film, a three-layer structure in which a titanium film, an aluminum film, and a titanium film are stacked in this order, and the like can be given. Alternatively, an alloy film containing aluminum and one or more metals selected from titanium, tantalum, tungsten, molybdenum, chromium, neodymium, and scandium; or a nitride film of the alloy film may be used.

The gate electrode 102 can also be formed using a light-transmitting conductive material such as indium tin oxide, indium oxide containing tungsten oxide, indium zinc oxide containing tungsten oxide, indium oxide containing titanium oxide, indium tin oxide containing titanium oxide, indium zinc oxide, or indium tin oxide to which silicon oxide is added. It is also possible to have a stacked-layer structure formed using the above light-transmitting conductive material and the above metal.

Further, an In—Ga—Zn-based oxynitride semiconductor film, an In—Sn-based oxynitride semiconductor film, an In—Ga-based oxynitride semiconductor film, an In—Zn-based oxynitride semiconductor film, a Sn-based oxynitride semiconductor film, an In-based oxynitride semiconductor film, a film of metal nitride (such as InN or ZnN), or the like may be provided between the gate electrode 102 and the insulating layer 103. These films each have a work function higher than or equal to 5 eV, preferably higher than or equal to 5.5 eV, which is higher than the electron affinity of the oxide semiconductor. Thus, the threshold voltage of the transistor including an oxide semiconductor can be shifted in the positive direction, and what is called a normally-off switching element can be achieved. For example, in the case of using an In—Ga—Zn-based oxynitride semiconductor film, an In—Ga—Zn-based oxynitride semiconductor film having a higher nitrogen concentration than at least the oxide semiconductor layer 104, specifically, an In—Ga—Zn-based oxynitride semiconductor film having a nitrogen concentration of 7 at. % or higher is used.

### <<Insulating Layer 103>>

The insulating layer 103 functions as a gate insulating film. The insulating layer 103 in contact with the bottom surface of the oxide semiconductor layer 104 is preferably an amorphous film.

The insulating layer 103 may be formed to have a single-layer structure or a stacked-layer structure using, for example, one or more of silicon oxide, silicon oxynitride, silicon nitride oxide, silicon nitride, aluminum oxide, hafnium oxide, gallium oxide, Ga—Zn-based metal oxide, silicon nitride, and the like.

The insulating layer 103 may be formed using a high-k material such as hafnium silicate (HfSiOₓ), hafnium silicate to which nitrogen is added (HfSiₓO_{y}N_{z}), hafnium aluminate to which nitrogen is added (HfAlₓO_{y}N_{z}), hafnium oxide, or yttrium oxide, so that gate leakage current of the transistor can be reduced.

<<Pair of Electrodes 105a and 105b>>

The pair of electrodes 105a and 105b functions as a source electrode and a drain electrode of the transistor.

The pair of electrodes 105a and 105b can be formed to have a single-layer structure or a stacked-layer structure using, as a conductive material, any of metals such as aluminum, titanium, chromium, nickel, copper, yttrium, zirconium, molybdenum, silver, tantalum, and tungsten, or an alloy containing any of these metals as its main component. For example, a single-layer structure of an aluminum film containing silicon, a two-layer structure in which a titanium film is stacked over an aluminum film, a two-layer structure in which a titanium film is stacked over a tungsten film, a two-layer structure in which a copper film is stacked over a copper-magnesium-aluminum alloy film, a three-layer structure in which a titanium film or a titanium nitride film, an aluminum film or a copper film, and a titanium film or a titanium nitride film are stacked in this order, a three-layer structure in which a molybdenum film or a molybdenum nitride film, an aluminum film or a copper film, and a molybdenum film or a molybdenum nitride film are stacked in this order, and the like can be given. Note that a transparent conductive material containing indium oxide, tin oxide, or zinc oxide may be used.

### <<Insulating Layer 106, 107>>

The insulating layer 106 is preferably formed using an oxide insulating film containing oxygen at a higher proportion than oxygen in the stoichiometric composition. Part of oxygen is released by heating from the oxide insulating film containing oxygen at a higher proportion than oxygen in the stoichiometric composition. The oxide insulating film containing oxygen at a higher proportion than oxygen in the stoichiometric composition is an oxide insulating film in which the amount of released oxygen converted into oxygen atoms is greater than or equal to 1.0×10¹⁸ atoms/cm³, preferably greater than or equal to 3.0×10²⁰ atoms/cm³ in thermal desorption spectroscopy (TDS) analysis.

As the insulating layer 106, a silicon oxide film, a silicon oxynitride film, or the like can be formed.

Note that the insulating layer 106 also functions as a film which relieves damage to the oxide semiconductor layer 104 at the time of forming the insulating layer 107 later.

Alternatively, an oxide film transmitting oxygen may be provided between the insulating layer 106 and the oxide semiconductor layer 104.

As the oxide film transmitting oxygen, a silicon oxide film, a silicon oxynitride film, or the like can be formed. Note that in this specification, a “silicon oxynitride film” refers to a film that contains oxygen at a higher proportion than nitrogen, and a “silicon nitride oxide film” refers to a film that contains nitrogen at a higher proportion than oxygen.

The insulating layer 107 can be formed using an insulating film having a blocking effect against oxygen, hydrogen, water, and the like. It is possible to prevent outward diffusion of oxygen from the oxide semiconductor layer 104 and entry of hydrogen, water, or the like into the oxide semiconductor layer 104 from the outside by providing the insulating layer 107 over the insulating layer 106. As for the insulating film having a blocking effect against oxygen, hydrogen, water, and the like, a silicon nitride film, a silicon nitride oxide film, an aluminum oxide film, an aluminum oxynitride film, a gallium oxide film, a gallium oxynitride film, an yttrium oxide film, an yttrium oxynitride film, a hafnium oxide film, and a hafnium oxynitride film can be given as examples.

### Example of Manufacturing Method of Transistor

Next, an example of a manufacturing method of the transistor 100 illustrated in FIGS. 15A and 15B will be described.

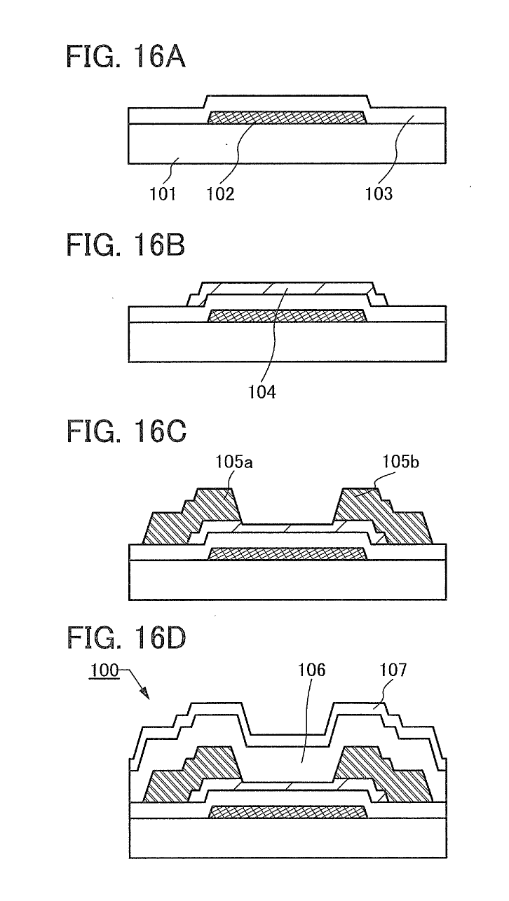

First, as illustrated in FIG. 16A, the gate electrode 102 is formed over the substrate 101, and the insulating layer 103 is formed over the gate electrode 102.

Here, a glass substrate is used as the substrate 101.

### <<Formation of Gate Electrode>>

A formation method of the gate electrode 102 is described below. First, a conductive film is formed by a sputtering method, a CVD method, an evaporation method, or the like and then a resist mask is formed over the conductive film using a first photomask by a photolithography process. Then, part of the conductive film is etched using the resist mask to form the gate electrode 102. After that, the resist mask is removed.

Note that instead of the above formation method, the gate electrode 102 may be formed by an electrolytic plating method, a printing method, an ink-jet method, or the like.

### <<Formation of Gate Insulating Layer>>

The insulating layer 103 is formed by a sputtering method, a CVD method, an evaporation method, or the like.

In the case where the insulating layer 103 is formed using a silicon oxide film, a silicon oxynitride film, or a silicon nitride oxide film, a deposition gas containing silicon and an oxidizing gas are preferably used as a source gas. Typical examples of the deposition gas containing silicon include silane, disilane, trisilane, and silane fluoride. As the oxidizing gas, oxygen, ozone, dinitrogen monoxide, and nitrogen dioxide can be given as examples.

In the case of forming a silicon nitride film as the insulating layer 103, it is preferable to use a two-step formation method. First, a first silicon nitride film with a small number of defects is formed by a plasma CVD method in which a mixed gas of silane, nitrogen, and ammonia is used as a source gas. Then, a second silicon nitride film in which the hydrogen concentration is low and hydrogen can be blocked is formed by switching the source gas to a mixed gas of silane and nitrogen. With such a formation method, a silicon nitride film with a small number of defects and a blocking property against hydrogen can be formed as the insulating layer 103.

Moreover, in the case of forming a gallium oxide film as the insulating layer 103, a metal organic chemical vapor deposition (MOCVD) method can be employed.

### <<Formation of Oxide Semiconductor Layer>>

Next, as illustrated in FIG. 16B, the oxide semiconductor layer 104 is formed over the insulating layer 103.

A formation method of the oxide semiconductor layer 104 is described below. First, an oxide semiconductor film is formed. Then, a resist mask is formed over the oxide semiconductor film using a second photomask by a photolithography process. Then, part of the oxide semiconductor film is etched using the resist mask to form the oxide semiconductor layer 104. After that, the resist mask is removed.

After that, heat treatment may be performed. In such a case, the heat treatment is preferably performed under an atmosphere containing oxygen.

### <<Formation of Pair of Electrodes>>

Next, as illustrated in FIG. 16C, the pair of electrodes 105a and 105b is formed.

A formation method of the pair of electrodes 105a and 105b is described below. First, a conductive film is formed by a sputtering method, a CVD method, an evaporation method, or the like. Then, a resist mask is formed over the conductive film using a third photomask by a photolithography process. Then, part of the conductive film is etched using the resist mask to form the pair of electrodes 105a and 105b. After that, the resist mask is removed.

Note that as illustrated in FIG. 16B, an upper part of the oxide semiconductor layer 104 is in some cases partly etched and thinned by the etching of the conductive film. For this reason, the oxide semiconductor layer 104 is preferably formed thick.

### <<Formation of Insulating Layer>>

Next, as illustrated in FIG. 16D, the insulating layer 106 is formed over the oxide semiconductor layer 104 and the pair of electrodes 105a and 105b, and the insulating layer 107 is successively formed over the insulating layer 106.

In the case where the insulating layer 106 is formed using a silicon oxide film or a silicon oxynitride film, a deposition gas containing silicon and an oxidizing gas are preferably used as a source gas. Typical examples of the deposition gas containing silicon include silane, disilane, trisilane, and silane fluoride. As the oxidizing gas, oxygen, ozone, dinitrogen monoxide, and nitrogen dioxide can be given as examples.

For example, a silicon oxide film or a silicon oxynitride film is formed under the conditions as follows: the substrate placed in a treatment chamber of a plasma CVD apparatus, which is vacuum-evacuated, is held at a temperature higher than or equal to 180° C. and lower than or equal to 260° C., preferably higher than or equal to 200° C. and lower than or equal to 240° C., the pressure is greater than or equal to 100 Pa and less than or equal to 250 Pa, preferably greater than or equal to 100 Pa and less than or equal to 200 Pa with introduction of a source gas into the treatment chamber, and high-frequency power higher than or equal to 0.17 W/cm² and lower than or equal to 0.5 W/cm², preferably higher than or equal to 0.25 W/cm² and lower than or equal to 0.35 W/cm² is supplied to an electrode provided in the treatment chamber.

As the film formation conditions, the high-frequency power having the above power density is supplied to the treatment chamber having the above pressure, whereby the decomposition efficiency of the source gas in plasma is increased, oxygen radicals are increased, and oxidation of the source gas is promoted; therefore, oxygen is contained in the oxide insulating film at a higher proportion than oxygen in the stoichiometric composition. However, in the case where the substrate temperature is within the above temperature range, the bond between silicon and oxygen is weak, and accordingly, part of oxygen is released by heating. Thus, it is possible to form an oxide insulating film which contains oxygen at a higher proportion than oxygen in the stoichiometric composition and from which part of oxygen is released by heating.

Further, in the case of providing an oxide insulating film between the oxide semiconductor layer 104 and the insulating layer 106, the oxide insulating film serves as a protective film for the oxide semiconductor layer 104 in the steps of forming the insulating layer 106. Thus, the insulating layer 106 can be formed using the high-frequency power having a high power density while damage to the oxide semiconductor layer 104 is reduced.

For example, a silicon oxide film or a silicon oxynitride film is formed as the oxide insulating film under the conditions as follows: the substrate placed in a treatment chamber of a plasma CVD apparatus, which is vacuum-evacuated, is held at a temperature higher than or equal to 180° C. and lower than or equal to 400° C., preferably higher than or equal to 200° C. and lower than or equal to 370° C., the pressure is greater than or equal to 20 Pa and less than or equal to 250 Pa, preferably greater than or equal to 100 Pa and less than or equal to 250 Pa with introduction of a source gas into the treatment chamber, and high-frequency power is supplied to an electrode provided in the treatment chamber. Further, when the pressure in the treatment chamber is greater than or equal to 100 Pa and less than or equal to 250 Pa, damage to the oxide semiconductor layer 104 can be reduced.

A deposition gas containing silicon and an oxidizing gas are preferably used as a source gas of the oxide insulating film. Typical examples of the deposition gas containing silicon include silane, disilane, trisilane, and silane fluoride. As the oxidizing gas, oxygen, ozone, dinitrogen monoxide, and nitrogen dioxide can be given as examples.

The insulating layer 107 can be formed by a sputtering method, a CVD method, or the like.

In the case where the insulating layer 107 is formed using a silicon nitride film or a silicon nitride oxide film, a deposition gas containing silicon, an oxidizing gas, and a gas containing nitrogen are preferably used as a source gas. Typical examples of the deposition gas containing silicon include silane, disilane, trisilane, and silane fluoride. As the oxidizing gas, oxygen, ozone, dinitrogen monoxide, and nitrogen dioxide can be given as examples. As the gas containing nitrogen, nitrogen and ammonia can be given as examples.

Through the above process, the transistor 100 can be formed.

### Modification Example of Transistor 100

A structural example of a transistor, which is partly different from the transistor 100, will be described below.

### Modification Example 1

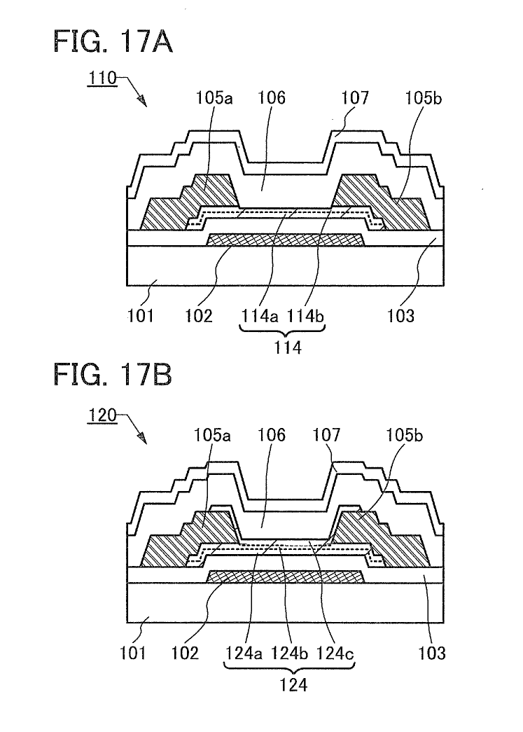

FIG. 17A is a schematic cross-sectional view of a transistor 110 described as an example below. The transistor 110 is different from the transistor 100 in the structure of an oxide semiconductor layer.

In an oxide semiconductor layer 114 included in the transistor 110, an oxide semiconductor layer 114a and an oxide semiconductor layer 114b are stacked.

Since a boundary between the oxide semiconductor layer 114a and the oxide semiconductor layer 114b is unclear in some cases, the boundary is shown by a dashed line in FIG. 17A and the like.

The oxide semiconductor film of one embodiment of the present invention can be applied to one or both of the oxide semiconductor layers 114a and 114b.

Typical examples of a material that can be used for the oxide semiconductor layer 114a are an In—Ga oxide, an In—Zn oxide, and an In-M—Zn oxide (M is Al, Ti, Ga, Y, Zr, La, Ce, Nd, or Hf). When an In-M—Zn oxide is used for the oxide semiconductor layer 114a, the atomic ratio between In and M is preferably as follows: the atomic percentage of In is less than 50 at. % and the atomic percentage of M is greater than or equal to 50 at. %; further preferably, the atomic percentage of In is less than 25 at. % and the atomic percentage of M is greater than or equal to 75 at. %. Further, a material having an energy gap of 2 eV or more, preferably 2.5 eV or more, further preferably 3 eV or more is used for the oxide semiconductor layer 114a, for example.

For example, the oxide semiconductor layer 114b contains In or Ga; the oxide semiconductor layer 114b contains, for example, a material typified by an In—Ga oxide, an In—Zn oxide, or an In-M—Zn oxide (M is Al, Ti, Ga, Y, Zr, La, Ce, Nd, or Hf). In addition, the energy of the conduction band minimum of the oxide semiconductor layer 114b is closer to the vacuum level than that of the oxide semiconductor layer 114a is. The difference between the energy of the conduction band minimum of the oxide semiconductor layer 114b and the energy of the conduction band minimum of the oxide semiconductor layer 114a is preferably 0.05 eV or more, 0.07 eV or more, 0.1 eV or more, or 0.15 eV or more and 2 eV or less, 1 eV or less, 0.5 eV or less, or 0.4 eV or less.

When an In-M—Zn oxide is used for the oxide semiconductor layer 114b, for example, the atomic ratio between In and M is preferably as follows: the atomic percentage of In is greater than or equal to 25 at. % and the atomic percentage of M is less than 75 at. %; further preferably, the atomic percentage of In is greater than or equal to 34 at. % and the atomic percentage of M is less than 66 at. %.

For the oxide semiconductor layer 114a, an In—Ga—Zn oxide containing In, Ga, and Zn at an atomic ratio of 1:1:1 or 3:1:2 can be used, for example. Further, for the oxide semiconductor layer 114b, an In—Ga—Zn oxide containing In, Ga, and Zn at an atomic ratio of 1:3:2, 1:6:4, or 1:9:6 can be used. Note that the atomic ratio of each of the oxide semiconductor layers 114a and 114b varies within a range of ±20% of the above atomic ratio as an error.

When an oxide containing a large amount of Ga that serves as a stabilizer is used for the oxide semiconductor layer 114b provided over the oxide semiconductor layer 114a, oxygen can be prevented from being released from the oxide semiconductor layers 114a and 114b.

Note that, without limitation to those described above, a material with an appropriate composition may be used depending on required semiconductor characteristics and electrical characteristics (e.g., field-effect mobility and threshold voltage) of a transistor. Further, in order to obtain required semiconductor characteristics of a transistor, it is preferable that the carrier density, the impurity concentration, the defect density, the atomic ratio of a metal element to oxygen, the interatomic distance, the density, and the like of the oxide semiconductor layers 114a and 114b be set to be appropriate.

Although a structure in which two oxide semiconductor layers are stacked is described above as an example of the oxide semiconductor layer 114, a structure in which three or more oxide semiconductor layers are stacked can also be employed.

### Modification Example 2

FIG. 17B is a schematic cross-sectional view of a transistor 120 described as an example below. The transistor 120 is different from the transistor 100 and the transistor 110 in the structure of an oxide semiconductor layer.

In an oxide semiconductor layer 124 included in the transistor 120, an oxide semiconductor layer 124a, an oxide semiconductor layer 124b, and an oxide semiconductor layer 124c are stacked in this order.

The oxide semiconductor layers 124a and 124b are stacked over the insulating layer 103. The oxide semiconductor layer 124c is provided in contact with the top surface of the oxide semiconductor layer 124b and the top surfaces and side surfaces of the pair of electrodes 105a and 105b.

The oxide semiconductor layer 124b can have a structure which is similar to that of the oxide semiconductor layer 114a described as an example in Modification Example 1, for example. Further, the oxide semiconductor layers 124a and 124c can each have a structure which is similar to that of the oxide semiconductor layer 114b described as an example in Modification Example 1, for example.

When an oxide containing a large amount of Ga that serves as a stabilizer is used for the oxide semiconductor layer 124a, which is provided under the oxide semiconductor layer 124b, and the oxide semiconductor layer 124c, which is provided over the oxide semiconductor layer 124b, for example, oxygen can be prevented from being released from the oxide semiconductor layer 124a, the oxide semiconductor layer 124b, and the oxide semiconductor layer 124c.

In the case where a channel is mainly formed in the oxide semiconductor layer 124b, for example, an oxide containing a large amount of In can be used for the oxide semiconductor layer 124b and the pair of electrodes 105a and 105b is provided in contact with the oxide semiconductor layer 124b; thus, the on-state current of the transistor 120 can be increased.

### Another Structure Example of Transistor

A structure example of a top-gate transistor to which the oxide semiconductor film of one embodiment of the present invention can be applied will be described below.

Note that descriptions of components having structures or functions similar to those of the above, which are denoted by the same reference numerals, are omitted below.

### Structural Example

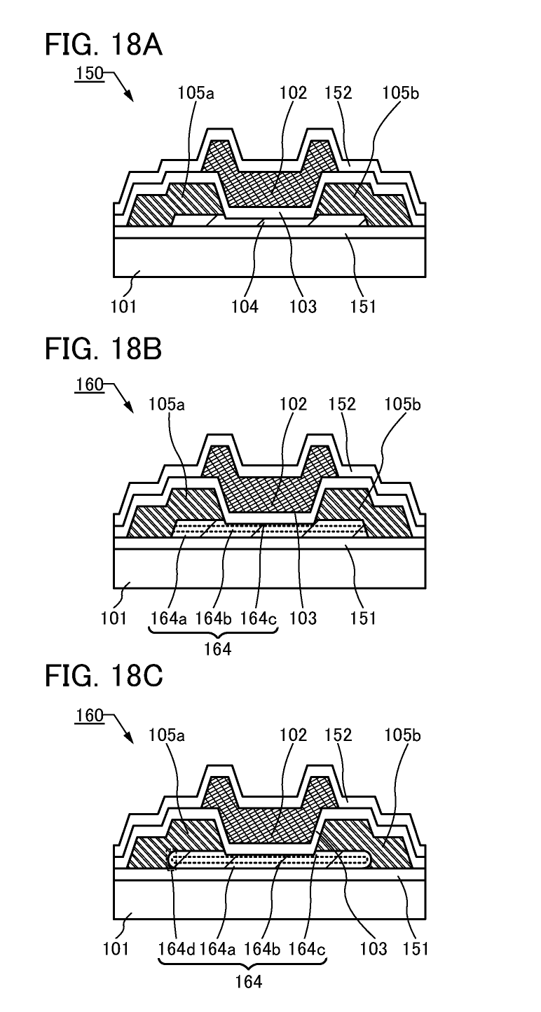

FIG. 18A is a schematic cross-sectional view of a top-gate transistor 150 which will be described below as an example.

The top-gate transistor 150 includes the oxide semiconductor layer 104 over the substrate 101 on which an insulating layer 151 is provided, the pair of electrodes 105a and 105b in contact with the top surface of the oxide semiconductor layer 104, the insulating layer 103 over the oxide semiconductor layer 104 and the pair of electrodes 105a and 105b, and the gate electrode 102 provided over the insulating layer 103 so as to overlap with the oxide semiconductor layer 104. Further, an insulating layer 152 is provided to cover the insulating layer 103 and the gate electrode 102.

The insulating layer 151 has a function of suppressing diffusion of impurities from the substrate 101 into the oxide semiconductor layer 104. For example, a structure similar to that of the insulating layer 107 can be employed. Note that the insulating layer 151 is not necessarily provided.

The insulating layer 152 can be formed using an insulating film having a blocking effect against oxygen, hydrogen, water, and the like in a manner similar to that of the insulating layer 107. Note that the insulating layer 107 is not necessarily provided.

### Modification Example

A structural example of a transistor, which is partly different from the top-gate transistor 150, will be described below.

FIG. 18B is a schematic cross-sectional view of a transistor 160 described as an example below. The structure of an oxide semiconductor layer in the transistor 160 is different from that in the top-gate transistor 150.

In an oxide semiconductor layer 164 included in the transistor 160, an oxide semiconductor layer 164a, an oxide semiconductor layer 164b, and an oxide semiconductor layer 164c are stacked in this order.

The oxide semiconductor film of one embodiment of the present invention can be applied to one or more of the oxide semiconductor layer 164a, the oxide semiconductor layer 164b, and the oxide semiconductor layer 164c.

The oxide semiconductor layer 164b can have a structure which is similar to that of the oxide semiconductor layer 114a described as an example in Modification Example 1, for example. Further, the oxide semiconductor layers 164a and 164c can each have a structure which is similar to that of the oxide semiconductor layer 114b described as an example in Modification Example 1, for example.

An oxide containing a large amount of Ga that serves as a stabilizer is used for the oxide semiconductor layer 124a, which is provided under the oxide semiconductor layer 164b, and the oxide semiconductor layer 164c, which is provided over the oxide semiconductor layer 164b, for example; thus, oxygen can be prevented from being released from the oxide semiconductor layer 164a, the oxide semiconductor layer 164b, and the oxide semiconductor layer 164c.

The oxide semiconductor layer 164 can be formed in the following manner: the oxide semiconductor layer 164c and the oxide semiconductor layer 164b are obtained by etching, so that an oxide semiconductor film to be the oxide semiconductor layer 164a is exposed; and the oxide semiconductor film is processed into the oxide semiconductor layer 164a by a dry etching method. In that case, a reaction product of the oxide semiconductor film is attached to side surfaces of the oxide semiconductor layers 164b and 164c to form a sidewall protective layer (also referred to as a rabbit ear) in some cases. Note that the reaction product is attached by a sputtering phenomenon or through plasma at the time of the dry etching.

FIG. 18C is a schematic cross-sectional view of a transistor 160 in which a sidewall protective layer 164d is formed as a side surface of the oxide semiconductor layer 164 in the above manner.

The sidewall protective layer 164d mainly contains the same material as the oxide semiconductor layer 164a. In some cases, the sidewall protective layer 164d contains the constituent (e.g., silicon) of a layer provided under the oxide semiconductor layer 164a (the insulating layer 151 here).

With a structure in which a side surface of the oxide semiconductor layer 164b is covered with the sidewall protective layer 164d so as not to be in contact with the pair of electrodes 105a and 105b as illustrated in FIG. 18C, unintended leakage current of the transistor in an off state can be reduced particularly when a channel is mainly formed in the oxide semiconductor layer 164b; thus, a transistor having favorable off-state characteristics can be fabricated. Further, when a material containing a large amount of Ga that serves as a stabilizer is used for the sidewall protective layer 164d, oxygen can be effectively prevented from being released from the side surface of the oxide semiconductor layer 164b; thus, a transistor having excellent stability of electrical characteristics can be fabricated.

This embodiment can be combined with any of the other embodiments disclosed in this specification as appropriate.

### Embodiment 9

Examples of a semiconductor and a semiconductor film which are preferably used for the region where a channel is formed in the transistor which is shown as an example in the above embodiment are described below.

An oxide semiconductor has a wide energy gap of 3.0 eV or more. A transistor including an oxide semiconductor film obtained by processing of the oxide semiconductor in an appropriate condition and a sufficient reduction in carrier density of the oxide semiconductor can have much lower leakage current between a source and a drain in an off state (off-state current) than a conventional transistor including silicon.

In the case where an oxide semiconductor film is used for a transistor, the thickness of the oxide semiconductor film is preferably greater than or equal to 2 nm and less than or equal to 40 nm

An oxide semiconductor containing at least indium (In) or zinc (Zn) is preferably used. In particular, In and Zn are preferably contained. In addition, as a stabilizer for reducing variation in electrical characteristics of a transistor using the oxide semiconductor, one or more elements selected from gallium (Ga), tin (Sn), hafnium (Hf), zirconium (Zr), titanium (Ti), scandium (Sc), yttrium (Y), and a lanthanoid (such as cerium (Ce), neodymium (Nd), or gadolinium (Gd)) is preferably contained.

As the oxide semiconductor, for example, an indium oxide, a tin oxide, a zinc oxide, an In—Zn-based oxide, a Sn—Zn-based oxide, an Al—Zn-based oxide, a Zn—Mg-based oxide, a Sn—Mg-based oxide, an In—Mg-based oxide, an In—Ga-based oxide, an In—Ga—Zn-based oxide (also referred to as IGZO), an In—Al—Zn-based oxide, an In—Sn—Zn-based oxide, a Sn—Ga—Zn-based oxide, an Al—Ga—Zn-based oxide, a Sn—Al—Zn-based oxide, an In—Hf—Zn-based oxide, an In—Zr—Zn-based oxide, an In—Ti—Zn-based oxide, an In—Sc—Zn-based oxide, an In—Y—Zn-based oxide, an In—La—Zn-based oxide, an In—Ce—Zn-based oxide, an In—Pr—Zn-based oxide, an In—Nd—Zn-based oxide, an In—Sm—Zn-based oxide, an In—Eu—Zn-based oxide, an In—Gd—Zn-based oxide, an In—Tb—Zn-based oxide, an In—Dy—Zn-based oxide, an In—Ho—Zn-based oxide, an In—Er—Zn-based oxide, an In—Tm—Zn-based oxide, an In—Yb—Zn-based oxide, an In—Lu—Zn-based oxide, an In—Sn—Ga—Zn-based oxide, an In—Hf—Ga—Zn-based oxide, an In—Al—Ga—Zn-based oxide, an In—Sn—Al—Zn-based oxide, an In—Sn—Hf—Zn-based oxide, or an In—Hf—Al—Zn-based oxide can be used.

Here, an “In—Ga—Zn-based oxide” means an oxide containing In, Ga, and Zn as main components and there is no limitation on the ratio of In:Ga:Zn. Further, a metal element in addition to In, Ga, and Zn may be contained.

Alternatively, a material represented by InMO₃(ZnO)ₘ (m>0, where m is not an integer) may be used as the oxide semiconductor. Note that M represents one or more metal elements selected from Ga, Fe, Mn, and Co, or the above-described element as a stabilizer. Alternatively, a material represented by In₂SnO₅(ZnO)ₙ (n>0, where n is an integer) may be used as the oxide semiconductor.

For example, an In—Ga—Zn-based oxide with an atomic ratio of In:Ga:Zn=1:1:1, In:Ga:Zn=1:3:2, In:Ga:Zn=3:1:2, or In:Ga:Zn=2:1:3, or an oxide with an atomic ratio close to the above atomic ratios can be used.

When the oxide semiconductor film contains a large amount of hydrogen, the hydrogen and an oxide semiconductor are bonded to each other, so that part of the hydrogen serves as a donor and causes generation of an electron which is a carrier. As a result, the threshold voltage of the transistor shifts in the negative direction. Therefore, after formation of the oxide semiconductor film, it is preferable that dehydration treatment (dehydrogenation treatment) be performed to remove hydrogen or moisture from the oxide semiconductor film so that the oxide semiconductor film is highly purified to contain impurities as little as possible.

Note that oxygen in the oxide semiconductor film is also reduced by the dehydration treatment (dehydrogenation treatment) in some cases. Therefore, it is preferable that oxygen be added to the oxide semiconductor film to fill oxygen vacancies increased by the dehydration treatment (dehydrogenation treatment). In this specification and the like, supplying oxygen to an oxide semiconductor film may be expressed as oxygen adding treatment, or treatment for making the oxygen content of an oxide semiconductor film be in excess of that of the stoichiometric composition may be expressed as treatment for making an oxygen-excess state.

In this manner, hydrogen or moisture is removed from the oxide semiconductor film by the dehydration treatment (dehydrogenation treatment) and oxygen vacancies therein are filled by the oxygen adding treatment, whereby the oxide semiconductor film can be turned into an i-type (intrinsic) oxide semiconductor film or a substantially i-type (intrinsic) oxide semiconductor film which is extremely close to an i-type oxide semiconductor film. Note that “substantially intrinsic” means that the oxide semiconductor film contains extremely few (close to zero) carriers derived from a donor and has a carrier density of lower than or equal to 1×10¹⁷/cm³, lower than or equal to 1×10¹⁶/cm³, lower than or equal to 1×10¹⁵/cm³, lower than or equal to 1×10¹⁴/cm³, or lower than or equal to 1×10¹³/cm³.

Thus, the transistor including an i-type or substantially i-type oxide semiconductor film can have extremely favorable off-state current characteristics. For example, the drain current at the time when the transistor including an oxide semiconductor film is in an off state can be less than or equal to 1×10⁻¹⁸ A, preferably less than or equal to 1×10⁻²¹ A, further preferably less than or equal to 1×10⁻²⁴ A at room temperature (about 25° C.); or less than or equal to 1×10⁻¹⁵ A, preferably less than or equal to 1×10⁻¹⁸ A, further preferably less than or equal to 1×10⁻²¹ A at 85° C. An off state of a transistor refers to a state where gate voltage is sufficiently lower than the threshold voltage in an n-channel transistor. Specifically, the transistor is in an off state when the gate voltage is lower than the threshold voltage by 1 V or more, 2 V or more, or 3 V or more.

The oxide semiconductor film may be either single crystal or non-single-crystal. In the latter case, the oxide semiconductor may be either amorphous or polycrystal.

Further, the oxide semiconductor may have either an amorphous structure including a portion having crystallinity or a non-amorphous structure.

Preferably, a CAAC-OS (c-axis aligned crystalline oxide semiconductor) film can be used as the oxide semiconductor film.

In each of the crystal parts included in the CAAC-OS film, a c-axis is aligned in a direction parallel to a normal vector of a surface where the CAAC-OS film is formed or a normal vector of a surface of the CAAC-OS film, triangular or hexagonal atomic arrangement which is seen from the direction perpendicular to the a-b plane is formed, and metal atoms are arranged in a layered manner or metal atoms and oxygen atoms are arranged in a layered manner when seen from the direction perpendicular to the c-axis. Note that, among crystal parts, the directions of an a-axis and a b-axis of one crystal part may be different from those of another crystal part. In this specification, a simple term “perpendicular” includes a range from 85° to 95°. In addition, a simple term “parallel” includes a range from −5° to 5°.

In the CAAC-OS film, distribution of crystal parts is not necessarily uniform. For example, in the formation process of the CAAC-OS film, in the case where crystal growth occurs from a surface side of the oxide semiconductor film, the proportion of crystal parts in the vicinity of the surface of the oxide semiconductor film is higher than that in the vicinity of the surface where the oxide semiconductor film is formed in some cases.

Further, when an impurity is added to the CAAC-OS film, crystallinity of the crystal part in a region to which the impurity is added becomes lower in some cases.

Since the c-axes of the crystal parts included in the CAAC-OS film are aligned in the direction parallel to a normal vector of a surface where the CAAC-OS film is formed or a normal vector of a surface of the CAAC-OS film, the directions of the c-axes may be different from each other depending on the shape of the CAAC-OS film (the cross-sectional shape of the surface where the CAAC-OS film is formed or the cross-sectional shape of the surface of the CAAC-OS film). Note that when the CAAC-OS film is formed, the direction of c-axis of the crystal part is the direction parallel to a normal vector of the surface where the CAAC-OS film is formed or a normal vector of the surface of the CAAC-OS film. The crystal part is formed by film formation or by performing treatment for crystallization such as heat treatment after film formation.

In a transistor using the CAAC-OS film, change in electrical characteristics due to irradiation with visible light or ultraviolet light is small. Thus, the transistor has high reliability.

For example, the CAAC-OS film can be formed by a sputtering method with a polycrystalline oxide semiconductor sputtering target. When ions collide with the sputtering target, a crystal region included in the sputtering target may be separated from the target by cleavage along an a-b plane; in other words, a sputtered particle having a plane parallel to the a-b plane (flat-plate-like sputtered particle or pellet-like sputtered particle) may flake off from the sputtering target. In that case, the flat-plate-like or pellet-like sputtered particle reaches a surface where the CAAC-OS film is formed while maintaining their crystal state, whereby the CAAC-OS film can be formed.

The flat-plate-like sputtered particle has, for example, an equivalent circle diameter of a plane parallel to the a-b plane of greater than or equal to 3 nm and less than or equal to 10 nm, and a thickness (length in the direction perpendicular to the a-b plane) of greater than or equal to 0.7 nm and less than 1 nm Note that in the flat-plate-like sputtered particle, the plane parallel to the a-b plane may be a regular triangle or a regular hexagon. Here, the term “equivalent circle diameter” refers to the diameter of a perfect circle having the same area as the plane.

For the deposition of the CAAC-OS, the following conditions are preferably used.

When the substrate temperature during the deposition is increased, migration of the flat-plate-like sputtered particles which have reached the substrate occurs, so that a flat plane of each sputtered particle is attached to the substrate. At this time, the sputtered particles are positively charged, thereby being attached to the substrate while repelling each other; thus, the sputtered particles are not stacked unevenly, so that a CAAC-OS film with a uniform thickness can be deposited. Specifically, the substrate temperature during the deposition is preferably higher than or equal to 100° C. and lower than or equal to 740° C., more preferably higher than or equal to 200° C. and lower than or equal to 500° C.

By reducing the amount of impurities entering the CAAC-OS film during the deposition, the crystal state can be prevented from being broken by the impurities. For example, the concentration of impurities (e.g., hydrogen, water, carbon dioxide, or nitrogen) which exist in the deposition chamber may be reduced. Furthermore, the concentration of impurities in a deposition gas may be reduced. Specifically, a deposition gas whose dew point is −80° C. or lower, preferably −100° C. or lower is used.

Furthermore, it is preferable that the proportion of oxygen in the deposition gas be increased and the power be optimized in order to reduce plasma damage at the deposition. The proportion of oxygen in the deposition gas is 30 vol % or higher, preferably 100 vol %.

After the CAAC-OS film is deposited, heat treatment may be performed. The temperature of the heat treatment is higher than or equal to 100° C. and lower than or equal to 740° C., preferably higher than or equal to 200° C. and lower than or equal to 500° C. The heat treatment time is longer than or equal to 1 minute and shorter than or equal to 24 hours, preferably longer than or equal to 6 minutes and shorter than or equal to 4 hours. The heat treatment may be performed in an inert atmosphere or an oxidizing atmosphere. It is preferable to perform heat treatment in an inert atmosphere and then perform heat treatment in an oxidizing atmosphere. The heat treatment in an inert atmosphere can reduce the concentration of impurities in the CAAC-OS in a short time. At the same time, the heat treatment in an inert atmosphere may generate oxygen vacancies in the CAAC-OS. In such a case, the heat treatment in an oxidizing atmosphere can reduce the oxygen vacancies. The heat treatment can further increase the crystallinity of the CAAC-OS. Note that the heat treatment may be performed under a reduced pressure, such as 1000 Pa or lower, 100 Pa or lower, 10 Pa or lower, or 1 Pa or lower. The heat treatment under the reduced pressure can reduce the concentration of impurities in the CAAC-OS in a shorter time.

As an example of the sputtering target, an In—Ga—Zn—O compound target is described below.

The In—Ga—Zn—O compound target which is polycrystalline is made by mixing InO_{X} powder, GaO_{Y} powder, and ZnO_{Z} powder in a predetermined molar ratio, applying pressure, and performing heat treatment at a temperature higher than or equal to 1000° C. and lower than or equal to 1500° C. Note that X, Y, and Z are given positive numbers. Here, the predetermined molar ratio of InO_{X} powder to GaO_{Y} powder and ZnO_{Z} powder is, for example, 1:1:1, 1:1:2, 1:3:2, 1:9:6, 2:1:3, 2:2:1, 3:1:1, 3:1:2, 3:1:4, 4:2:3, 8:4:3, or a ratio close to these ratios. The kinds of powder and the molar ratio for mixing powder may be determined as appropriate depending on the desired sputtering target.

Alternatively, the CAAC-OS may be formed by the following method.

First, a first oxide semiconductor film is formed to a thickness of greater than or equal to 1 nm and less than 10 nm. The first oxide semiconductor film is formed by a sputtering method. Specifically, the substrate temperature is set to higher than or equal to 100° C. and lower than or equal to 500° C., preferably higher than or equal to 150° C. and lower than or equal to 450° C., and the proportion of oxygen in a deposition gas is set to higher than or equal to 30 vol %, preferably 100 vol %.

Next, heat treatment is performed so that the first oxide semiconductor film becomes a first CAAC-OS with high crystallinity. The temperature of the heat treatment is higher than or equal to 350° C. and lower than or equal to 740° C., preferably higher than or equal to 450° C. and lower than or equal to 650° C. The heat treatment time is longer than or equal to 1 minute and shorter than or equal to 24 hours, preferably longer than or equal to 6 minutes and shorter than or equal to 4 hours. The heat treatment may be performed in an inert atmosphere or an oxidizing atmosphere. It is preferable to perform heat treatment in an inert atmosphere and then perform heat treatment in an oxidizing atmosphere. The heat treatment in an inert atmosphere can reduce the concentration of impurities in the first oxide semiconductor film in a short time. At the same time, the heat treatment in an inert atmosphere may generate oxygen vacancies in the first oxide semiconductor film. In such a case, the heat treatment in an oxidizing atmosphere can reduce the oxygen vacancies. Note that the heat treatment may be performed under a reduced pressure, such as 1000 Pa or lower, 100 Pa or lower, 10 Pa or lower, or 1 Pa or lower. The heat treatment under the reduced pressure can reduce the concentration of impurities in the first oxide semiconductor film in a shorter time.

The first oxide semiconductor film with a thickness of greater than or equal to 1 nm and less than 10 nm can be easily crystallized by heat treatment as compared to the case where the first oxide semiconductor film has a thickness of greater than or equal to 10 nm

Next, a second oxide semiconductor film having the same composition as the first oxide semiconductor film is formed to a thickness of greater than or equal to 10 nm and less than or equal to 50 nm. The second oxide semiconductor film is formed by a sputtering method. Specifically, the substrate temperature is set to higher than or equal to 100° C. and lower than or equal to 500° C., preferably higher than or equal to 150° C. and lower than or equal to 450° C., and the proportion of oxygen in a deposition gas is set to higher than or equal to 30 vol %, preferably 100 vol %.

Next, heat treatment is performed so that solid phase growth of the second oxide semiconductor film from the first CAAC-OS occurs, whereby the second oxide semiconductor film is turned into a second CAAC-OS having high crystallinity. The temperature of the heat treatment is higher than or equal to 350° C. and lower than or equal to 740° C., preferably higher than or equal to 450° C. and lower than or equal to 650° C. The heat treatment time is longer than or equal to 1 minute and shorter than or equal to 24 hours, preferably longer than or equal to 6 minutes and shorter than or equal to 4 hours. The heat treatment may be performed in an inert atmosphere or an oxidizing atmosphere. It is preferable to perform heat treatment in an inert atmosphere and then perform heat treatment in an oxidizing atmosphere. The heat treatment in an inert atmosphere can reduce the concentration of impurities in the second oxide semiconductor film in a short time. At the same time, the heat treatment in an inert atmosphere may generate oxygen vacancies in the second oxide semiconductor film. In such a case, the heat treatment in an oxidizing atmosphere can reduce the oxygen vacancies. Note that the heat treatment may be performed under a reduced pressure, such as 1000 Pa or lower, 100 Pa or lower, 10 Pa or lower, or 1 Pa or lower. The heat treatment under the reduced pressure can reduce the concentration of impurities in the second oxide semiconductor film in a shorter time.

In the above-described manner, a CAAC-OS film having a total thickness of 10 nm or more can be formed.

Further, the oxide semiconductor film may have a structure in which a plurality of oxide semiconductor films is stacked.

For example, a structure may be employed in which, between an oxide semiconductor film (referred to as a first layer for convenience) and a gate insulating film, a second layer which is formed using the constituent elements of the first layer and whose electron affinity is lower than that of the first layer by 0.2 eV or more is provided. In this case, when an electric field is applied from a gate electrode, a channel is formed in the first layer, and a channel is not formed in the second layer. The constituent elements of the first layer are the same as the constituent elements of the second layer, and thus interface scattering hardly occurs at the interface between the first layer and the second layer. Accordingly, when the second layer is provided between the first layer and the gate insulating film, the field-effect mobility of the transistor can be increased.

Further, in the case where a silicon oxide film, a silicon oxynitride film, a silicon nitride oxide film, or a silicon nitride film is used as the gate insulating film, silicon contained in the gate insulating film enters the oxide semiconductor film in some cases. When the oxide semiconductor film contains silicon, reductions in crystallinity and carrier mobility of the oxide semiconductor film occur, for example. Thus, it is preferable to provide the second layer between the first layer and the gate insulating film in order to reduce the concentration of silicon in the first layer where a channel is formed. For the same reason, it is preferable to provide a third layer which is formed using the constituent elements of the first layer and whose electron affinity is lower than that of the first layer by 0.2 eV or more so that the first layer is interposed between the second layer and the third layer.

Such a structure makes it possible to reduce and further prevent diffusion of impurities such as silicon to a region where a channel is formed, so that a highly reliable transistor can be obtained.

Note that in order to make the oxide semiconductor film a CAAC-OS, the concentration of silicon contained in the oxide semiconductor film is set to lower than or equal to 2.5×10²¹/cm³, preferably lower than 1.4×10²¹/cm³, more preferably lower than 4×10¹⁹/cm³, still more preferably lower than 2.0×10¹⁸/cm³. This is because the field-effect mobility of the transistor may be reduced when the concentration of silicon contained in the oxide semiconductor film is higher than or equal to 1.4×10²¹/cm³, and the oxide semiconductor film may be made amorphous at the interface between the oxide semiconductor film and a film in contact with the oxide semiconductor film when the concentration of silicon contained in the oxide semiconductor film is higher than or equal to 4.0×10¹⁹/cm³. Further, when the concentration of silicon contained in the oxide semiconductor film is lower than 2.0×10¹⁸/cm³, further improvement in reliability of the transistor and a reduction in density of states (DOS) in the oxide semiconductor film can be expected. Note that the concentration of silicon in the oxide semiconductor film can be measured by secondary ion mass spectrometry (SIMS).

This embodiment can be implemented in an appropriate combination with any of the other embodiments described in this specification.

### Embodiment 10

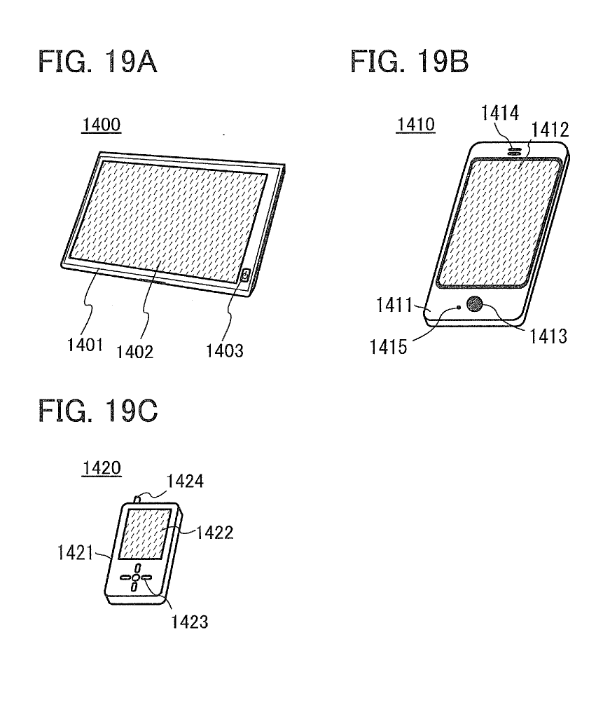

In this embodiment, specific examples of electronic devices each of which is manufactured using the liquid crystal display device described in any of the above embodiments are described with reference to FIGS. 19A to 19C.

Examples of electronic devices to which one embodiment of the present invention can be applied include a television set (also referred to as a television or a television receiver), a monitor of a computer or the like, a camera such as a digital camera or a digital video camera, a digital photo frame, a mobile phone, a portable game machine, a portable information terminal, an audio reproducing device, a game machine (e.g., a pachinko machine or a slot machine), and a game console. FIGS. 19A to 19C illustrate specific examples of these electronic devices.

FIG. 19A illustrates a portable information terminal 1400 including a display portion. The portable information terminal 1400 includes a display portion 1402 and an operation button 1403 which are incorporated in a housing 1401. The liquid crystal display device of one embodiment of the present invention can be used for the display portion 1402.

FIG. 19B illustrates a cellular phone 1410. The cellular phone 1410 includes a display portion 1412, an operation button 1413, a speaker 1414, and a microphone 1415 which are incorporated in a housing 1411. The liquid crystal display device of one embodiment of the present invention can be used for the display portion 1412.

FIG. 19C illustrates an audio reproducing device 1420. The audio reproducing device 1420 includes a display portion 1422, an operation button 1423, and an antenna 1424 which are incorporated in a housing 1421. In addition, the antenna 1424 transmits and receives data via a wireless signal. The liquid crystal display device of one embodiment of the present invention can be used for the display portion 1422.

The display portions 1402, 1412, and 1422 each have a touch-input function. When a user touches a displayed button (not illustrated) which is displayed on the display portion 1402, 1412, or 1422 with his/her fingers or the like, the user can carry out operation on the screen and input of information.

When the liquid crystal display device shown in any of the above embodiments is used for the display portions 1402, 1412, and 1422, the display quality of the display portions 1402, 1412, and 1422 can be improved.

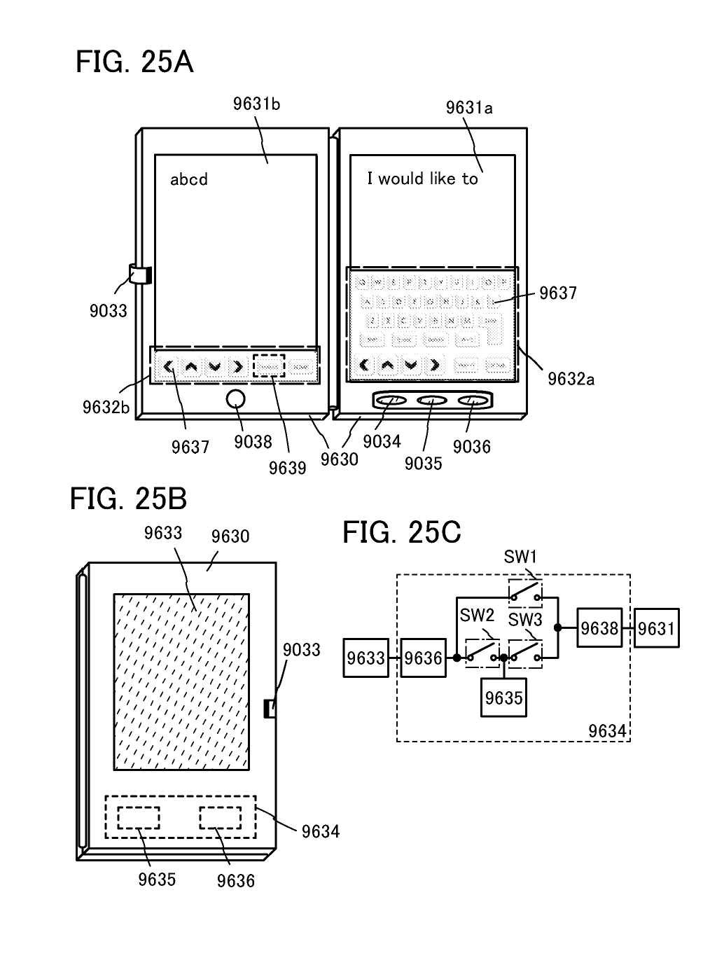

FIGS. 25A and 25B illustrate an example of a foldable tablet terminal. The tablet terminal is opened in FIG. 25A. The tablet terminal includes a housing 9630, a display portion 9631a, a display portion 9631b, a display mode switch 9034, a power switch 9035, a power saver switch 9036, a clasp 9033, and an operation switch 9038. Note that in the tablet, one or both of the display portion 9631a and the display portion 9631b is/are formed using a light-emitting device which includes the light-emitting element described in Embodiments 1 and 2.

Part of the display portion 9631a can be a touchscreen region 9632a and data can be input when a displayed operation key 9637 is touched. Note that FIG. 25A shows, as an example, that half of the area of the display portion 9631a has only a display function and the other half of the area has a touch panel function. However, the structure of the display portion 9631a is not limited to this, and all the area of the display portion 9631a may have a touch panel function. For example, all the area of the display portion 9631a can display keyboard buttons and serve as a touch panel while the display portion 9631b can be used as a display screen.

Like the display portion 9631a, part of the display portion 9631b can be a touchscreen region 9632b. A switching button 9639 for showing/hiding a keyboard of the touch panel is touched with a finger, a stylus, or the like, so that keyboard buttons can be displayed on the display portion 9631b.

Touch input can be performed in the touchscreen region 9632a and the touchscreen region 9632b at the same time.

The display mode switch 9034 for switching display modes can switch display orientation (e.g., between landscape mode and portrait mode) and select a display mode (switch between monochrome display and color display), for example. With the power saver switch 9036 for switching to power-saving mode, the luminance of display can be optimized in accordance with the amount of external light at the time when the tablet is in use, which is detected with an optical sensor incorporated in the tablet. The tablet may include another detection device such as a sensor for detecting orientation (e.g., a gyroscope or an acceleration sensor) in addition to the optical sensor.

Although the display portion 9631a and the display portion 9631b have the same display area in FIG. 25A, one embodiment of the present invention is not limited to this example, and they may be different in areas or display quality. For example, one of them may be a display panel that can display higher-definition images than the other.

FIG. 25B illustrates the tablet terminal which is folded. The tablet terminal in this embodiment includes the housing 9630, a solar battery 9633, a charge and discharge control circuit 9634, a battery 9635, and a DC-to-DC converter 9636. In FIG. 25B, a structure including the battery 9635 and the DCDC converter 9636 is illustrated as an example of the charge and discharge control circuit 9634.

Since the tablet can be folded in two, the housing 9630 can be closed when the tablet is not in use. Thus, the display portions 9631a and 9631b can be protected, thereby providing a tablet with high endurance and high reliability for long-term use.

The tablet terminal illustrated in FIGS. 25A and 25B can also have a function of displaying various kinds of data (e.g., a still image, a moving image, and a text image), a function of displaying a calendar, a date, the time, or the like on the display portion, a touch-input function of operating or editing data displayed on the display portion by touch input, a function of controlling processing by various kinds of software (programs), and the like.

The solar battery 9633, which is attached on the surface of the tablet terminal, supplies electric power to a touch panel, a display portion, an image signal processor, and the like. Note that the solar battery 9633 is preferably provided on one or two surfaces of the housing 9630, in which case the battery 9635 can be charged efficiently.

The structure and operation of the charge and discharge control circuit illustrated in FIG. 25B are described with reference to a block diagram of FIG. 25C.

FIG. 25C illustrates the solar battery 9633, the battery 9635, the DCDC converter 9636, a converter 9638, switches SW1 to SW3, and the display portion 9631. The battery 9635, the DCDC converter 9636, the converter 9638, and the switches SW1 to SW3 correspond to the charge and discharge control circuit 9634 in FIG. 25B.

First, an example of operation in the case where power is generated by the solar battery 9633 using external light is described. The voltage of power generated by the solar battery is raised or lowered by the DCDC converter 9636 so that the power has a voltage for charging the battery 9635. Then, when power supplied from the battery 9635 charged by the solar battery 9633 is used for the operation of the display portion 9631, the switch SW1 is turned on and the voltage of the power is raised or lowered by the converter 9638 so as to be voltage needed for the display portion 9631. In addition, when display on the display portion 9631 is not performed, the switch SW1 is turned off and a switch SW2 is turned on so that charge of the battery 9635 may be performed.

Although the solar battery 9633 is described as an example of a power generation means, the power generation means is not particularly limited, and the battery 9635 may be charged by another power generation means such as a piezoelectric element or a thermoelectric conversion element (Peltier element). The battery 9635 may be charged by a non-contact power transmission module which is capable of charging by transmitting and receiving power by wireless (without contact), or another charge means used in combination, and the power generation means is not necessarily provided.

One embodiment of the present invention is not limited to the tablet terminal having the shape illustrated in FIGS. 25A to 25C as long as the display portion 9631 is included.

This embodiment can be implemented in appropriate combination with any of the structures described in the other embodiments.

### Embodiment 11

In this embodiment, the significance of a reduction in refresh rate described in the above embodiments is explained.

The eye strain is divided into two categories: nerve strain and muscle strain.

The nerve strain is caused by prolonged looking at light emitted from a liquid crystal display device or blinking images. This is because the brightness stimulates and fatigues a retina, optic nerves, and a brain. The muscle strain is caused by overuse of a ciliary muscle which works for adjusting the focus.

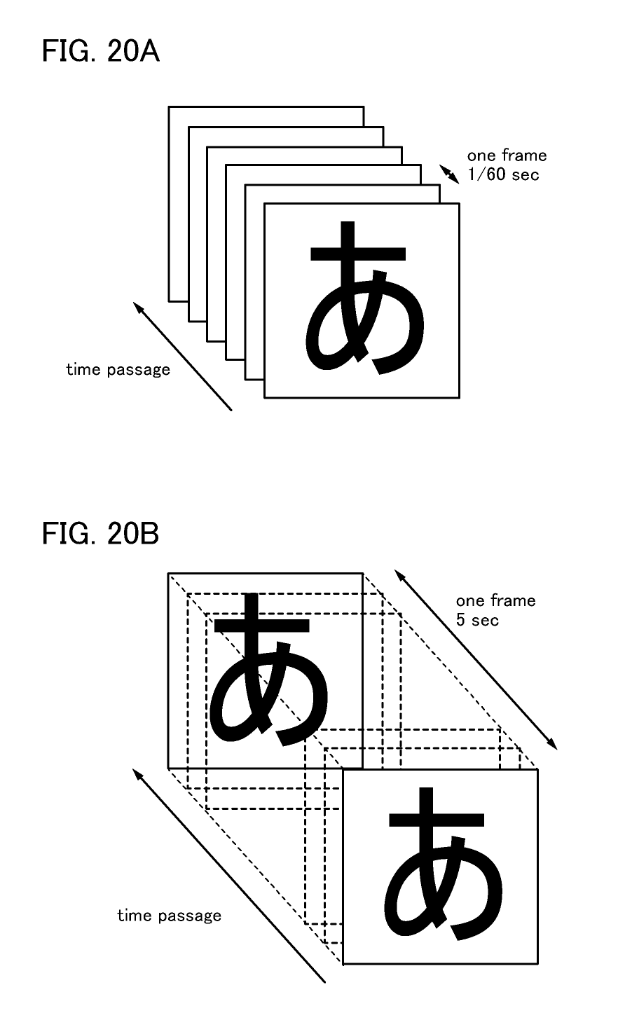

FIG. 20A is a schematic diagram illustrating display of a conventional liquid crystal display device. As illustrated in FIG. 20A, for the display of the conventional liquid crystal display device, image rewriting is performed 60 times per second. A prolonged looking at such a screen might stimulate a retina, optic nerves, and a brain of a user and lead to eye strain.

In one embodiment of the present invention, a transistor including an oxide semiconductor (e.g., a transistor including a CAAC-OS) is used in a pixel portion of a liquid crystal display device. Since the transistor has an extremely small off-state current, the luminance of the liquid crystal display device can be kept even when the frame frequency is decreased.

Thus, for example, the number of times of image writing can be reduced to 5 times per second as shown in FIG. 20B. The same image can be displayed for a long time as much as possible and flickers on a screen perceived by a user can be reduced. Therefore, stimuli to a retina, optic nerves, and a brain of a user are reduced, so that the strain is reduced.

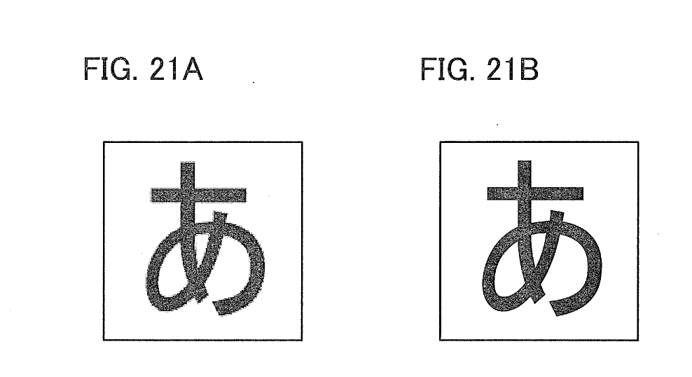

In the case where the size of one pixel is large (e.g., the resolution is less than 150 ppi), a blurred character is displayed by a liquid crystal display device as shown in FIG. 21A. When users look at the blurred character displayed on the liquid crystal display device for a long time, their ciliary muscles keep working to adjust the focus in a state where adjusting the focus is difficult, which might lead to eye strain.

In contrast, in the liquid crystal display device of one embodiment of the present invention, the size of one pixel is small and thus high resolution display is performed as shown in FIG. 21B, so that precise and smooth display can be achieved.

The precise and smooth display enables ciliary muscles to adjust the focus more easily, and reduces muscle strain of users.

Quantitative measurement of eye strain has been studied. For example, the critical flicker (fusion) frequency (CFF) is known as an index of measuring nerve strain; and the accommodation time and the accommodation near point are known as indexes of measuring muscle strain.

Examples of other methods for measuring eye strain include electroencephalography, thermography, measurement of the number of blinkings, measurement of tear volume, measurement of a pupil contractile response speed, and a questionnaire for surveying subjective symptoms.

One embodiment of the present invention can provide an eye-friendly liquid crystal display device.

This application is based on Japanese Patent Application serial No. 2012-286774 filed with Japan Patent Office on Dec. 28, 2012, the entire contents of which are hereby incorporated by reference.

What is claimed is:

1. A liquid crystal display device comprising a pixel for displaying a still image with a frame frequency of 1 Hz or lower,
wherein the pixel comprises a liquid crystal element which includes a liquid crystal layer,
wherein the liquid crystal layer comprises a liquid crystal composition which comprises a liquid crystal material, and
wherein a helical pitch of the liquid crystal material is longer than or equal to 20 μm and shorter than or equal to 40 μm.

2. The liquid crystal display device according to claim 1,
wherein the helical pitch of the liquid crystal material is longer than or equal to 20 μm and shorter than or equal to 30 μm.

3. The liquid crystal display device according to claim 1,
wherein the liquid crystal element is driven in a TN mode.

4. The liquid crystal display device according to claim 1,
wherein the frame frequency is 0.2 Hz or lower.

5. A liquid crystal display device comprising a pixel for displaying a still image with a frame frequency of 1 Hz or lower,
wherein the pixel comprises a transistor and a liquid crystal element which includes a liquid crystal layer,
wherein the liquid crystal layer comprises a liquid crystal composition which comprises a liquid crystal material, and
wherein a helical pitch of the liquid crystal material is longer than or equal to 20 μm and shorter than or equal to 40 μm.

6. The liquid crystal display device according to claim 5,
wherein the transistor comprises a semiconductor layer, and
wherein the semiconductor layer comprises an oxide semiconductor.

7. The liquid crystal display device according to claim 5,
wherein the helical pitch of the liquid crystal material is longer than or equal to 20 μm and shorter than or equal to 30 μm.

8. The liquid crystal display device according to claim 5,
wherein the liquid crystal element is driven in a TN mode.

9. The liquid crystal display device according to claim 5,
wherein the frame frequency is 0.2 Hz or lower.

10. A liquid crystal display device comprising a pixel,
wherein the pixel has a function of being supplied with an image signal with a frame frequency of 1 Hz or lower,
wherein the pixel has a function of displaying a still image,
wherein the pixel comprises a liquid crystal element,
wherein the liquid crystal element comprises a liquid crystal layer,
wherein the liquid crystal layer comprises a region whose cell gap is d (μm),
wherein the liquid crystal layer comprises a liquid crystal material, and
wherein the liquid crystal material comprises a region whose helical pitch is longer than or equal to 4d μm and shorter than or equal to 8d μm.

11. The liquid crystal display device according to claim 10,
wherein the helical pitch is longer than or equal to 4d and shorter than or equal to 6d.

12. The liquid crystal display device according to claim 10,
wherein the liquid crystal element is driven in a TN mode.

13. The liquid crystal display device according to claim 10,
wherein the frame frequency is 0.2 Hz or lower.

14. A liquid crystal display device comprising a pixel for displaying a still image with a frame frequency of 1 Hz or lower,
wherein the pixel comprises a transistor and a liquid crystal element which comprises a liquid crystal layer and which has a cell gap of d (μm),
wherein the liquid crystal layer includes a liquid crystal composition which comprises a liquid crystal material, and
wherein a helical pitch of the liquid crystal material is longer than or equal to 4d μm and shorter than or equal to 8d μm.

15. The liquid crystal display device according to claim 14,
wherein the transistor comprises a semiconductor layer, and
wherein the semiconductor layer comprises an oxide semiconductor.

16. The liquid crystal display device according to claim 14,
wherein the helical pitch is longer than or equal to 4d and shorter than or equal to 6d.

17. The liquid crystal display device according to claim 14,
wherein the liquid crystal element is driven in a TN mode.

18. The liquid crystal display device according to claim 14,
wherein the frame frequency is 0.2 Hz or lower.
